(19) United States
(12) Patent Application Publication
(10) Pub. No.: US 2018/0134972 A1
(43) Pub. Date: May 17, 2018

(54) PROCESSING OF CHALLENGED FRACTIONS AND CRACKED CO-FEEDS

(71) Applicant: ExxonMobil Research and Engineering Company, Annandale, NJ (US)

(72) Inventors: Stephen H. BROWN, Lebanon, NJ (US); Brian A. CUNNINGHAM, Tokyo (JP); Randolph J. SMILEY, Hellertown, PA (US); Samia ILIAS, Bridgewater, NJ (US); Jesse R. McMANUS, Houston, TX (US); Aldrin G. CUEVAS, The Woodlands, TX (US); Teng XU, Houston, TX (US); Gregory R. JOHNSON, Bound Brook, NJ (US); John P. GREELEY, Manasquan, NJ (US)

(21) Appl. No.: 15/790,223

(22) Filed: Oct. 23, 2017

Related U.S. Application Data
(60) Provisional application No. 62/422,094, filed on Nov. 15, 2016.
(60) Provisional application No. 62/504,702, filed on May 11, 2017.

(51) Int. Cl. C10G 45/20; C10G 67/02; C10L 1/04; C10G 45/08; B01J 8/02; B03C 5/02; B01D 21/02

(52) U.S. Cl. CPC C10G 45/20; C10L 2290/547; C10L 1/04; C10G 45/08; B01J 8/0278; B03C 5/02; B01D 21/02; C10G 2300/1003; C10G 2300/107; C10G 2300/202; C10G 2300/207; C10G 2300/208; C10G 2300/301; C10G 2300/308; C10L 2200/0438; C10L 2290/38; C10L 2290/543; C10L 2290/24; C10G 67/02

(57) ABSTRACT

Systems and methods are provided for upgrading blends of catalytic slurry oil and steam cracker tar to form fuel and/or fuel blending products. The steam cracker tar can optionally correspond to a fluxed steam cracker tar that includes steam cracker gas oil and/or another type of gas oil or other diluent. It has been unexpectedly discovered that blends of catalytic slurry oil and steam cracker tar can be hydroprocessed under fixed bed conditions while reducing or minimizing the amount of coke formation on the hydroprocessing catalyst and/or while reducing or minimizing plugging of the fixed bed, as would be conventionally expected during fixed bed processing of a feed containing a substantial portion of steam cracker tar. Additionally or alternately, it has been unexpectedly discovered that formation of coke fines within steam cracker tar can be reduced or minimized by blending steam cracker tar with catalytic slurry oil. This can facilitate fixed bed processing of the steam cracker tar, as after removal of particles the blend of catalytic slurry oil and steam cracker tar can maintain a reduced or minimized level of coke fines and/or other particles.

### CROSS-REFERENCE TO RELATED APPLICATIONS

This application claims the benefit of U.S. Provisional Application No. 62/504,702, filed on May 11, 2017 and U.S. Provisional Application No. 62/422,094, filed on Nov. 15, 2016, the entire contents of both which are incorporated herein by reference.

### FIELD

Systems and methods are provided for hydroprocessing of heavy aromatic fractions, such as blends of catalytic slurry oil fractions, steam cracker tar fractions, and/or deasphalter rock fractions.

### BACKGROUND

Fluid catalytic cracking (FCC) processes are commonly used in refineries as a method for converting feedstocks, without requiring additional hydrogen, to produce lower boiling fractions suitable for use as fuels. While FCC processes can be effective for converting a majority of a typical input feed, under conventional operating conditions at least a portion of the resulting products can correspond to a fraction that exits the process as a “bottoms” fraction.

This bottoms fraction can typically be a high boiling range fraction, such as a ˜650° F.+(−343° C.+) fraction. Because this bottoms fraction may also contain FCC catalyst fines, this fraction can sometimes be referred to as a catalytic slurry oil.

Steam cracking, also referred to as pyrolysis, has long been used to crack various hydrocarbon feedstocks into olefins, preferably light olefins such as ethylene, propylene, and butenes. Conventional steam cracking utilizes a pyrolysis furnace wherein the feedstock, typically comprising crude or a fraction thereof optionally desalted, is heated sufficiently to cause thermal decomposition of the larger molecules. Among the valuable and desirable products include light olefins such as ethylene, propylene, and butylenes. The pyrolysis process, however, also produces molecules that tend to combine to form high molecular weight materials known as steam cracked tar or steam cracker tar, hereinafter referred to as “SCT”. These are among the least valuable products obtained from the effluent of a pyrolysis furnace. In general, feedstocks containing higher boiling materials (“heavy feeds”) tend to produce greater quantities of SCT. It should be noted that the terms thermal pyrolysis unit, pyrolysis unit, and steam cracker are used synonymously herein; all refer to what is conventionally known as a steam cracker, even though steam is optional.

SCT is among the least desirable of the products of pyrolysis since it finds few uses. SCT tends to be incompatible with other “virgin” (meaning it has not undergone any hydrocarbon conversion process such as FCC or steam cracking) products of the refinery pipestill upstream from the steam cracker. At least one reason for such incompatibility is the presence of asphaltenes. Asphaltenes are high in molecular weight and can precipitate out when blended in even insignificant amounts into other materials, such as fuel oil streams.

Steam cracking processes are commonly used in refineries as a method for producing olefins from heavy oils or other low value fractions. A side product generated during steam cracking can be steam cracker tar. Steam cracker tar can typically be a highly aromatic product with a boiling range similar to a vacuum gas oil and/or a vacuum resid fraction. Conventionally, steam cracker tar can be difficult to process using a fixed bed reactor because various molecules within a steam cracker tar feed are highly reactive, leading to fouling and operability issues.

Such processing difficulties can be further complicated, for example, by the high viscosity of the feed, the presence of coke fines within a steam cracker tar feed, and/or other properties related to the composition of steam cracker tar.

Still another type of challenging fraction to process in a refinery setting is desaphalter residue or “rock” that is generated from a solvent deasphalting process. For some types of feeds, the deasphalter residue can be used to as an asphalt product and/or as a blendstock for forming an asphalt product. However, many types of deasphalter residue are not suitable for asphalt production, and the commercial demand for asphalt is often substantially lower than the available amount of deasphalter residue.

U.S. Patent Application Publication 2017/0002279 describes methods for fixed bed hydroprocessing of catalytic slurry oil under various conditions.

U.S. Patent Application Publication 2017/0022433 describes methods for fixed bed hydroprocessing of deasphalter rock with a co-feed under various conditions.

U.S. Pat. No. 7,279,090 describes a method for deasphalting a vacuum resid feed and processing the deasphalter rock using an ebullating bed reactor. The examples report 65% to 70% conversion of the deasphalter rock processed in the ebullating bed reactor. The deasphalted oil can be processed either in a fixed bed reactor or an ebullating bed reactor.

### SUMMARY

In an aspect, a method for processing a feed including steam cracker tar is provided. The method includes exposing a feed to a hydrotreating catalyst in a fixed bed under effective hydrotreating conditions to form a hydrotreated effluent. The feed can include a) about 60 wt % to about 99 wt % (or about 70 wt % to about 99 wt %) of a catalytic slurry oil portion that includes a ˜650° F.+(˜343° C.+) portion and that has an I_{N} of at least about 50. The feed can further include b) about 1.0 wt % to about 30 wt % of a steam cracker tar portion. The catalytic slurry oil portion and the steam cracker tar portion can refer to portions prior to any particle separation and/or portions that have been exposed to at least one particle separation process. The feed can have a total particle content of about 100 wppm or less and an API gravity of 7 or less. A liquid portion of the hydrotreated effluent can have an API gravity that is at least 5 greater than the API gravity of the feed (or at least 10 greater, or at least 15 greater). Optionally, the feed can further include 1 wt % to 30 wt % of a flux, the flux having a T5 boiling point of at least 343° C.

Optionally, the feed can be formed by separating a feedstock comprising the catalytic slurry oil portion and the steam cracker tar portion to form at least a first separation effluent comprising the feed and a second separation effluent. Prior to separation, the feedstock can have a total particle content of at least about 200 wppm (or at least about 500 wppm, or at least about 1000 wppm). The second separation effluent can comprise at least about 200 wppm of particles having a particle size of 25 μm or greater. In some aspects, separating the feedstock can include settling the feedstock in a settling vessel for a settling time to form a settler effluent and a settler bottoms, the settler bottoms comprising at least about 200 wppm of particles having a particle size of 25 μm or greater. In some aspects, separating the feedstock can include passing at least a portion of the feedstock (such as the settler effluent) into an electrostatic separation stage to form a first electrostatic separation effluent having a total particle content lower than the total particle content of the feedstock and a second electrostatic separation effluent having a greater total particle content than the feedstock. Optionally, at least one of the catalytic slurry oil portion and the steam cracker tar portion can correspond to a portion that has been exposed to a prior particle removal process, such as a separation process to form at least first separation effluent and a second separation effluent. Optionally, at least one of the catalytic slurry oil portion and the steam cracker tar portion can correspond to a portion that has not been exposed to a prior particle removal process.

In some aspects, the feed can include about 3 wt % to about 10 wt % of a ˜1050° F.+(˜566° C.+) portion, the effective hydrotreating conditions being effective for conversion of at least about 50 wt % of a ˜566° C.+ portion of the feed and/or first separation effluent, the effective hydrotreating conditions optionally consuming at least about 1500 SCF/bbl (˜260 Nm³/m³) of hydrogen. Additionally or alternately, the feed can further include about 10 wt % or less of a fraction different from a catalytic slurry oil portion or a steam cracker tar portion. Additionally or alternately, the feed can further include at least about 5 wt % of the steam cracker tar portion, or at least about 10 wt %, or at least about 15 wt %. Additionally or alternately, the feed can have a T10 distillation point of at least about 343° C. Additionally or alternately, the feed can have a total particle content of about 50 wppm or less, or about 25 wppm or less.

In another aspect, a hydroprocessing system is provided. The hydroprocessing system can include a settling tank. The hydroprocessing system can further include one or more stages of electrostatic separators comprising at least one separator stage inlet in fluid communication with the settling tank for receiving a settler effluent and at least one separator stage outlet. The hydroprocessing system can further include a hydroprocessing reactor comprising a reactor inlet in fluid communication with the at least one separator stage outlet and a reactor outlet, the hydroprocessing reactor further comprising at least one fixed bed containing a hydroprocessing catalyst. Optionally, the settling tank can include a settler bottoms outlet in fluid communication with at least one of a coker, a fluid catalytic cracker, or a fuel oil pool. In some aspects, the one or more stages of electrostatic separators can comprise electrostatic separators arranged in series, electrostatic separators arranged in parallel, or a combination thereof. The one or more stages of electrostatic separators can optionally further comprise a separator stage flush outlet in fluid communication with at least one of a coker, a fluid catalytic cracker, or a fuel oil pool.

In still another aspect, a liquid portion of a hydrotreated effluent formed by processing a feed including steam cracker tar is provided. The hydrotreated effluent can be formed by the method that includes separating a feed comprising a) about 60 wt % to about 99 wt % (or about 70 wt % to about 99 wt %) of a catalytic slurry oil portion that includes a ˜650° F.+(˜343° C.+) portion and that has an I_{N} of at least about 50 and b) about 1.0 wt % to about 30 wt % of a steam cracker tar portion to form at least a first separation effluent having a total particle content of about 100 wppm or less and a second separation effluent comprising at least about 200 wppm of particles having a particle size of 25 μm or greater. The first separation effluent can then be exposed to a hydrotreating catalyst in a fixed bed under effective hydrotreating conditions to form a hydrotreated effluent. The first separation effluent can have an API gravity of 7 or less. The liquid portion of the hydrotreated effluent having an API gravity of at least 5 and/or the API gravity of the liquid portion of the hydrotreated effluent can be at least 5 greater than the API gravity of the feed (or at least 10 greater, or at least 15 greater).

In yet another aspect, a method for processing a feed including deasphalter rock under slurry hydroprocessing conditions is provided. The method includes exposing a feed comprising deasphalter rock and a co-feed to a slurry hydroprocessing catalyst under slurry hydroprocessing conditions to form a hydroprocessed effluent. The deasphalter rock can include at least 10 wt % n-heptane insolubles relative to a weight of the deasphalter rock. The co-feed can have 10 wt % or less of n-heptane insolubles and/or a S_{BN} of about 90 or more and/or a T10 distillation point of at least 343° C. and/or a T90 distillation point of 566° C. or less. The feed can include about 20 wt % or more of the co-feed and about 10 wt % or more of the deasphalter rock. Additionally, 50 wt % or more of the feed can correspond to the co-feed and the deasphalter rock.

In some aspects, the feed can include 30 wt % or more of the deasphalter rock, or 50 wt % or more. The deasphalter rock can optionally include at least 20 wt % n-heptane insolubles, or at least 40 wt %. In some aspects, the feed can include 30 wt % or more of the co-feed, or 50 wt % or more. The co-feed can correspond to a catalytic slurry oil, a steam cracker tar, a coker gas oil, an aromatics extract fraction, or a combination thereof. In some aspects, 70 wt % or more of the feed can correspond to the co-feed and the deasphalter rock, or 80 wt % or more.

In still other aspects, a feed including deasphalter rock for processing under slurry hydroprocessing conditions is provided. The feed can include deasphalter rock, co-feed, and about 100 wppm to about 1000 wppm of catalyst particles, such as catalyst particles comprising Mo and/or a Group VIB metal.

### BRIEF DESCRIPTION OF THE FIGURES

FIG. 1 shows an example of a reaction system for processing a blended feed including catalytic slurry oil and steam cracker tar.

FIG. 2 shows settling rates for particles in a steam cracker tar feed.

FIG. 3 shows settling rates for a steam cracker tar feed and a feed including steam cracker tar and an aromatic fluid.

FIG. 4 shows settling rates for a feed including steam cracker tar and an aromatic fluid.

FIG. 5 shows results from hydrotreatment of a catalytic slurry oil.

FIG. 6 shows results from hydrotreatment of a catalytic slurry oil relative to results for hydrotreatment of a blended feed.

FIG. 7 shows results from hydrotreatment of a catalytic slurry oil relative to results for hydrotreatment of a blended feed.

FIG. 8 shows an example of a reaction system for slurry hydroprocessing.

FIG. 9 shows the amount of toluene insolubles in the hydroprocessing effluent from slurry hydroprocessing of deasphalter rock, steam cracker tar, or a blend of deasphalter rock and steam cracker tar.

FIG. 10 shows the amount of toluene insolubles in the hydroprocessing effluent from slurry hydroprocessing of deasphalter rock with various co-feeds.

### DETAILED DESCRIPTION

In various aspects, systems and methods are provided for upgrading of challenged feeds in the presence of a co-feed via hydroprocessing. The type of hydroprocessing that is suitable for upgrading of a challenged feed can be dependent on the nature of the challenged feed. For a challenged feed corresponding to a steam cracker tar, the challenged feed can be processed under fixed bed hydroprocessing conditions in the presence of a catalytic slurry oil co-feed. For a challenged feed corresponding to deasphalter rock, which has a substantial content of micro carbon residue and/or n-heptane insoluble compounds, the challenged feed can be processed under slurry hydroprocessing conditions in the presence of a co-feed corresponding to a cracked feed. The cracked feed can correspond to a substantially vacuum gas oil boiling range feed with a high solubility blending number.

In some aspects, systems and methods are provided for upgrading blends of catalytic slurry oil and steam cracker tar to form naphtha boiling range and/or distillate boiling range and/or residual fuel products. In such aspects, the steam cracker tar can correspond to a challenged feed. The steam cracker tar can optionally correspond to a fluxed steam cracker tar that includes steam cracker gas oil and/or another type of gas oil or other diluent. A fluxed steam cracker tar feed can have improved viscosity and/or flow properties. It has been unexpectedly discovered that blends of catalytic slurry oil and steam cracker tar can be hydroprocessed under fixed bed conditions while reducing or minimizing the amount of coke formation on the hydroprocessing catalyst and/or while reducing or minimizing plugging of the fixed bed, as would be conventionally expected during fixed bed processing of a feed containing a substantial portion of steam cracker tar. Additionally or alternately, it has been unexpectedly discovered that formation of coke fines within steam cracker tar can be reduced or minimized by blending steam cracker tar with catalytic slurry oil. This can facilitate fixed bed processing of the steam cracker tar, as after removal of particles the blend of catalytic slurry oil and steam cracker tar can maintain a reduced or minimized level of coke fines and/or other particles. Hydrotreating can be an example of a suitable type of hydroprocessing that can be performed as a fixed bed process after removal of fines from a blend of catalytic slurry oil and steam cracker tar.

Steam cracker tar (SCT) can correspond to a side product or residual product generated during steam cracking of a heavy oil feed for production of olefins. Conventional fixed bed processing of SCT is generally not practical for various reasons. As a standalone feed, SCT can quickly foul fixed bed processing units. Without being bound by any particular theory, this is believed to be due in part to asphaltenes within the SCT becoming insoluble during hydroprocessing, resulting in asphaltene precipitation within the fixed catalyst bed. In particular, SCT can have relatively high values for both S_{BN} and I_{N}. Because S_{BN} can drop substantially more rapidly than I_{N} during hydroprocessing that results in conversion of a feed (such as conversion relative to 700° F./˜371° C. or conversion relative to 1050° F./˜566° C.), attempts to hydroprocess SCT in a meaningful manner can quickly result in fouling and/or plugging of fixed bed reactors. Attempting to co-process SCT with other feeds can potentially exacerbate this difficulty, as most conventional refinery feeds can have starting S_{BN} values that are substantially less than SCT. Additionally, portions of an SCT feed can have a viscosity and/or other flow properties that can result in portions of an SCT feed adhering to surfaces within processing equipment, leading to further fouling. Still an additional problem can be the tendency for SCT to generate additional coke fines, solid asphaltenes, or other particles. When an SCT is filtered to remove particles, equilibrium processes can cause additional particles to form within the SCT. These particles can contribute to plugging of fixed bed catalyst beds. Due to one or more of these difficulties, fixed bed processing of SCT can typically be avoided in a refinery setting. Instead, SCT is often used as a component of a fuel oil pool, which corresponds to a relatively low value use.

In various aspects, one or more of the above difficulties can be overcome by using a blend of steam cracker tar portion and catalytic slurry oil portion (i.e., bottoms from an FCC process) as a feed for production of naphtha and distillate boiling range fuel products. In this discussion, references to a steam cracker tar or a steam cracker tar portion are considered interchangeable unless otherwise specified. It is noted a steam cracker tar or steam cracker tar portion is defined to include steam cracker tars and/or steam cracker tar portions that have passed through a separation stage to reduce the particle content. Similarly, references to a catalytic slurry oil or catalytic slurry oil portion are considered interchangeable unless otherwise specified, and are defined to include catalytic slurry oils and/or catalytic slurry oil portions that have passed through a separation stage to reduce the particle content.

In various aspects, the blended feed can include at least about 0.1 wt % steam cracker tar, or at least about 1.0 wt %, or at least about 5.0 wt %, or at least about 10 wt %. Additionally or alternately, the feed can include about 30 wt % or less of steam cracker tar, or about 25 wt % or less, or about 20 wt % or less, or about 15 wt % or less, or about 10 wt % or less. In particular, a feed can include about 0.1 wt % to about 25 wt % of steam cracker tar, or about 0.1 wt % to about 30 wt %, or about 1.0 wt % to about 20 wt %. In some aspects, the blended feed can further include 1.0 wt % to 30 wt % of a “flux” (or 1.0 wt % to 20 wt %, or 1.0 wt % to 10 wt %), either in the form of a separately added flux or in the form of a fluxed steam cracker tar. For example, the blended feed can optionally include at least about 1.0 wt % flux, or at least about 5.0 wt %, or at least about 10 wt %, and/or about 30 wt % or less, or about 25 wt % or less, or about 20 wt % or less, or about 10 wt % or less. The blended feed can further include at least about 50 wt % catalyst slurry oil, or at least about 60 wt %, or at least about 70 wt %, or at least about 80 wt %, or at least about 90 wt %. Additionally or alternately, the feed can contain about 99 wt % or less of catalytic slurry oil, or about 95 wt % or less, or about 90 wt % or less. In particular, a feed can include about 50 wt % to about 99 wt % catalytic slurry oil, or about 50 wt % to about 90 wt %, or about 70 wt % to about 99 wt %. Optionally, the feed can be substantially composed of catalytic slurry oil and steam cracker tar, with less than about 10 wt % of other feed components, or less than about 5.0 wt %, or less than about 1.0 wt %, or less than about 0.1 wt %. In particular, the feed can optionally include about 0 wt % to about 10 wt % of other components, or about 0 wt % to about 5.0 wt %, or about 0.1 wt % to about 5.0 wt %, or about 0.1 wt % to about 1.0 wt %. In contrast to many types of potential feeds for production of fuels, the asphaltenes in a blend of catalytic slurry oil and steam cracker tar can apparently be converted on a time scale comparable to the time scale for conversion of other aromatic compounds in the catalytic slurry oil. This can have the effect that during hydroprocessing, the rate of decrease of the S_{BN} for a blend of catalytic slurry oil and steam cracker tar can be similar to the rate of decrease of I_{N}, so that precipitation of asphaltenes during processing can be reduced, minimized, or eliminated. As a result, it has been unexpectedly discovered that blends of catalytic slurry oil and steam cracker tar can be processed at effective hydroprocessing conditions for substantial conversion of the feed without causing excessive coking of the catalyst.

An additional favorable feature of hydroprocessing a blended feed of steam cracker tar and catalytic slurry oil can be the increase in product volume that can be achieved. Due to the high percentage of aromatic cores in steam cracker tar and/or catalytic slurry oil, hydroprocessing of such a blend can result in substantial consumption of hydrogen. The additional hydrogen added to a blend of steam cracker tar and catalytic slurry oil can result in an increase in volume for the hydroprocessed effluent. The additional hydrogen for the hydrotreatment can be provided from any convenient source.

For example, hydrogen can be generated via steam reforming of a shale gas or another natural gas type feed. In such an example, input streams corresponding to inexpensive catalytic slurry oil and inexpensive hydrogen derived from U.S. shale gas can be combined to produce liquid propane gas (LPG), gasoline, diesel / distillate fuels, and/or (ultra) low sulfur fuel oil. By processing a feed composed of a blend of catalytic slurry oil and steam cracker tar, the incompatibility that occurs with conventional blended feedstocks can be avoided.

In some aspects, hydroprocessing within the normal range of commercial hydrotreater operations can enable 1500-4000 SCF/bbl (˜260 Nm³/m³ to ˜690 Nm³/m³) of hydrogen to be added to a feed including catalytic slurry oil and SCT. This can result in substantial conversion of a feed to 700° F.−(371° C.−) products, such as at least about 40 wt % conversion to 371° C.− products, or at least about 50 wt %, or at least about 60 wt %, and up to about 90 wt % or more. In some aspects, the ˜371° C.− product can meet the requirements for a low sulfur diesel fuel blendstock in the U.S. Additionally or alternately, the ˜371° C.− product(s) can be upgraded by further hydroprocessing to a low sulfur diesel fuel or blendstock. The remaining ˜700° F.+(˜371° C.+) product optionally can meet the normal specifications for a <0.5 wt % S bunker fuel or a <0.1 wt % S bunker fuel, and/or may be blended with a distillate range blendstock to produce a finished blend that can meet the specifications for a <˜0.1 wt % S bunker fuel. It is noted that in some aspects, the substantial conversion of the feed described above can correspond to conversion relative to 750° F. (399° C.) rather than 371° C. Additionally or alternately, the low sulfur diesel fuel blendstock described above can, in some aspects, correspond to a ˜399° C.− product instead of a ˜371° C.− product. In such aspects, the ˜399° C.+ product can optionally meet the specifications for a <0.5 wt % S bunker fuel or a <0.1 wt % S bunker fuel. Additionally or alternately, a ˜343° C.+ product can be formed that can be suitable for use as a <0.1 wt % S bunker fuel without additional blending.

Another option for characterizing conversion can be to characterize conversion relative to 1050° F. (566° C.). A blend of catalytic slurry oil and (optionally fluxed) SCT may only contain a few weight percent of 566° C.+ components, such as about 3 wt % to about 15 wt %. However, under a conventional understanding, conversion of more than about 50% of this 566° C.+ portion would be expected to lead to rapid coking and plugging of a fixed bed hydrotreatment reactor. It has been unexpectedly determined that the hydrotreatment conditions described herein can allow for at least about 50% conversion of 566° C.+ compounds with only minimal coke formation. In various aspects, the amount of conversion of 566° C.+ components to 566° C.− components can be at least about 50 wt %, or at least about 60 wt %, or at least about 70 wt %, or at least about 80 wt %, such as up to substantially complete conversion of 566° C.+ components. In particular, the amount of conversion of 566° C.+ components to ˜66° C.− components can be about 50 wt % to about 100 wt %, or about 60 wt % to about 100 wt %, or about 70 wt % to about 100 wt %.

As an alternative to fixed bed hydroprocessing, in various aspects catalytic slurry oil, steam cracker tar, and/or high solvency aromatic petroleum fractions can be blended with deasphalter residue or “rock” to form a feedstock for hydroprocessing under slurry hydroconversion conditions. In such alternative aspects, the deasphalter rock can correspond to the challenged feed. Other high solvency aromatic petroleum fractions can include, but are not limited to, coker bottoms and aromatic extract fractions generated during solvent processing to form lubricant base oils. More generally, high solvency aromatic petroleum fractions can correspond to fractions having a T10 to T90 distillation range of roughly 343° C.-538° C. (or 343° C.−566° C.). A high solvency aromatic fraction can also have an S_{BN} of about 90 or more, or about 100 or more, or about 110 or more, or about 120 or more, such as up to about 250 or possibly still higher. Additionally or alternately, a high solvency aromatic fraction can have a I_{N} of about 50 or more, or about 70 or more, or about 90 or more. Such fractions can typically correspond to cracked fractions, as fractions derived from a virgin crude source typically have lower S_{BN} values due to low aromatic content and/or high paraffin content. By contrast, cracked fractions can include higher concentrations of polycyclic aromatics without aliphatic side chains, and lower concentrations of paraffins.

Slurry hydroconversion is a process that can be beneficial for processing of various types of feeds that have a low ratio of hydrogen to carbon. For example, one option for upgrading a vacuum resid boiling range feed can be to use the vacuum resid as a feed to a coker. While this can result in some upgrading of the feed to fuels boiling range products, as much as 20 wt % to 50 wt % of the feed can be converted to coke, a low value product. Slurry hydroconversion can potentially provide an alternative method for processing a vacuum resid feed while reducing the production of coke, due in part to the ability to add hydrogen to the feed during the slurry hydroconversion. In particular, for typical/conventional types of feeds for slurry hydroconversion, an advantage of slurry hydroconversion can be the ability to produce relatively constant amounts of slurry hydroconversion “pitch” (or unconverted material) in spite of increasing amounts of Conradson carbon reside or micro carbon residue within a feedstock. Because the amount of coke generated by a coker is typically strongly correlated with the micro carbon residue content of a feed, slurry hydroconversion can provide increasing benefits as the micro carbon residue of a feed increases.

In some refinery settings, the volume of vacuum resid feed that requires processing can be reduced by first performing solvent deasphalting. Solvent deasphalting is typically performed using a small alkane as a solvent (C₃-C₇), and can result in production of a deasphalted oil fraction and a residue or rock fraction that is incompatible with the deasphalting solvent. The deasphalted oil fraction can be beneficial, as such a fraction can typically be processed using conventional refinery methods. However, the deasphalter rock fraction can present challenges. For certain feeds, the rock fraction can correspond to an asphalt that is suitable for use in commercial asphalt applications. However, this disposition of the rock is often not available for quality and/or economic reasons. Thus, further processing (such as coking) is often required for a deasaphalter residue or rock fraction.

Using deasphalter rock as a feed to a conventional coker can result in coke yields of 50 wt % or greater relative to the weight of the feed. Such high coke yields can often lead to a situation where it is not economically favorable to perform coking on a deasphalter rock fraction. This could make slurry hydroconversion a beneficial option for processing of rock. Deaspahlter residue or rock, however, can also be a challenging fraction for slurry hydroconversion due to a high concentration of n-heptane insolubles (asphaltenes). Although slurry hydroconversion can produce relatively stable amounts of pitch for a wide variety of feeds, the concentrated asphaltenes in deasphalter rock can lead to elevated levels of toluene insoluble compounds in the slurry hydroconversion product, as determined according to ASTM D4072. Depending on the nature of a deasphalting process and the feed to the deasphalting unit, a rock fraction can have a micro carbon residue content of 40 wt % or more and/or a n-heptane insolubles content of about 10 wt % or more, or about 20 wt % or more, or about 30 wt % or more, such as up to 50 wt % or still higher. The concentration of n-heptane insoluble compounds and/or micro carbon residue can tend toward higher values for rock fractions formed during deasphalting with a C₅₊ solvent. Without being bound by any particular theory, it is believed that the elevated content of n-heptane insoluble compounds can cause an incompatible mesophase to form when processing a rock fraction under slurry hydroprocessing conditions. The incompatible mesophase can correspond to a semi-solid phase that primarily includes stacked, partially hydroconverted asphaltenes. When molecules in the mesophase form radicals, the radicals can readily condense with other molecules in the mesophase to form toluene insoluble compounds that appear to correspond to traditional coke. This production of coke (and/or additional toluene insoluble compounds), which does not occur for conventional slurry hydroprocessing feeds, can lead to additional production of pitch, thus reducing or minimizing one of the key benefits of slurry hydroconversion processes.

One option to attempt to reduce the toluene insolubles generated during slurry hydroprocessing a rock fraction could be to dilute the rock with virgin vacuum gas oil. Unfortunately, virgin vacuum gas oil fractions can tend to have a relatively low aromatics content, such as roughly 25 wt % or less. As a result, attempting to perform slurry hydroprocessing on a mixed feed of deasphalter rock and virgin vacuum gas oil can tend to result in phase separation and/or inhomogeneity within the reactor, which can pose problems for maintaining control over the processing conditions.

It has been discovered that the amount of coke/excess toluene insoluble compounds formed during slurry hydroprocessing of deasphalter residue or rock can be reduced or minimized by co-processing the rock with a high solvency aromatic petroleum fraction. Preferably, the deasphalter rock can be combined with a co-feed (in the form of a high solvency aromatic fraction) that has a solubility number comparable to or higher than deasphalter rock, such as about 90 or more, or about 110 or more, or about 120 or more, and that exhibits similar reduction rates for solubility number and insolubility number during hydroprocessing. An example of such a co-feed is an FCC bottoms fraction and/or another high solvency aromatic co-feed. The amount of such co-feed added to the deasphalter rock can be any convenient amount up to about 90 wt %, or about 10 wt % to 80 wt %, or about 20 wt % to about 70 wt %, or about 40 wt % to about 90 wt %. Including at least 10 wt % of a high solvency aromatic fraction as a co-feed can provide a synergistic benefit, as the amount of reduction in toluene insolubles observed in the slurry hydroconversion product is reduced by more than the amount expected from simple dilution of the feed. In various aspects, the amount of deasphalter rock in a feed for slurry hydroconversion can be at least about 10 wt % of the feed, or about 10 wt % to 70 wt %, or about 20 wt % to about 60 wt %, or at least about 30 wt %, or at least about 40 wt %, or at least about 50 wt %, or at least about 60 wt %. In combination, the amount of deasphalter rock and co-feed (i.e., high solvency aromatic compounds) can correspond to about 50 wt % or more of the feed, or about 70 wt % or more, or about 80 wt % or more, such as up to substantially all of the feed.

In some aspects, additional advantages can be achieved in reducing the toluene insolubles generated from slurry hydroprocessing of a feedstock including deasphalter rock and a co-feed when the feedstock is slurry hydroprocessed in the presence of a lower amount of hydroprocessing catalyst. In such aspects, the amount of hydroprocessing catalyst in the slurry hydroprocessing environment can correspond to 1000 wppm of catalyst or less, or 500 wppm of catalyst or less. If a target coke yield is desired, sufficient dilution with co-feed can be used to maintain a target coke yield while using less catalyst. Operating at a low catalyst concentration can provide a variety of potential advantages. For example, less catalyst use translates to lower operating costs. Additionally, less catalyst means less inorganic matter goes into the pitch byproduct. This can improve the value of the pitch and can potentially enable additional pitch dispositions and/or subsequent processing options. It is noted that the amount toluene insolubles generated during slurry hydroprocessing includes any catalyst present during processing. However, at low catalyst concentrations, the amount of toluene insolubles can roughly correspond to the amount of coke in the pitch byproduct.

As defined herein, the term “hydrocarbonaceous” includes compositions or fractions that contain hydrocarbons and hydrocarbon-like compounds that may contain heteroatoms typically found in petroleum or renewable oil fraction and/or that may be typically introduced during conventional processing of a petroleum fraction. Heteroatoms typically found in petroleum or renewable oil fractions include, but are not limited to, sulfur, nitrogen, phosphorous, and oxygen. Other types of atoms different from carbon and hydrogen that may be present in a hydrocarbonaceous fraction or composition can include alkali metals as well as trace transition metals (such as Ni, V, or Fe).

In this discussion, reference may be made to catalytic slurry oil, FCC bottoms, and main column bottoms. These terms can be used interchangeably herein. It can be noted that when initially formed, a catalytic slurry oil can include several weight percent of catalyst fines.

Such catalyst fines can optionally be removed (such as partially removed to a desired level) by any convenient method, such as settling, filtration, dilution, or a combination thereof. Any such catalyst fines can be removed prior to incorporating a fraction derived from a catalytic slurry oil into a product pool, such as a naphtha fuel pool or a diesel fuel pool. In this discussion, unless otherwise explicitly noted, references to a catalytic slurry oil are defined to include catalytic slurry oil either prior to or after such a process for reducing the content of catalyst fines within the catalytic slurry oil.

In some aspects, reference may be made to conversion of a feedstock relative to a conversion temperature. Conversion relative to a temperature can be defined based on the portion of the feedstock that boils at greater than the conversion temperature at standard pressure (˜1 atmosphere; ˜100 kPa-a). The amount of conversion during a process (or optionally across multiple processes) can correspond to the weight percentage of the feedstock converted from boiling above the conversion temperature to boiling below the conversion temperature. As an illustrative hypothetical example, consider a feedstock that includes 40 wt % of components that boil at 700° F. (371° C.) or greater. By definition, the remaining 60 wt % of the feedstock boils at less than 700° F. (371° C.). For such a feedstock, the amount of conversion relative to a conversion temperature of 371° C. would be based only on the 40 wt % that initially boils at 371° C. or greater.

In various aspects, reference may be made to one or more types of fractions generated during distillation of a petroleum feedstock. Such fractions may include naphtha fractions, kerosene fractions, diesel fractions, and vacuum gas oil fractions. Each of these types of fractions can be defined based on a boiling range, such as a boiling range that includes at least 90 wt % of the fraction, or at least 95 wt % of the fraction. For example, for many types of naphtha fractions, at least 90 wt % of the fraction, or at least 95 wt %, can have a boiling point in the range of ˜85° F. (˜29° C.) to ˜350° F. (˜177° C.). For some heavier naphtha fractions, at least 90 wt % of the fraction, or at least 95 wt %, can have a boiling point in the range of ˜85° F. (˜29° C.) to ˜400° F. (˜204° C.). For a kerosene fraction, at least 90 wt % of the fraction, or at least 95 wt %, can have a boiling point in the range of ˜300° F. (˜149° C.) to ˜600° F. (˜288° C.). For a kerosene fraction targeted for some uses, such as jet fuel production, at least 90 wt % of the fraction, or at least 95 wt %, can have a boiling point in the range of ˜300° F. (˜149° C.) to ˜550° F. (˜288° C.). For a diesel fraction, at least 90 wt % of the fraction, or at least 95 wt %, can have a boiling point in the range of ˜400° F. (˜204° C.) to ˜750° F. (˜399° C.). For a (vacuum) gas oil fraction, at least 90 wt % of the fraction, and preferably at least 95 wt %, can have a boiling point in the range of ˜650° F. (˜343° C.) to ˜1100° F. (˜593° C.). Optionally, for some gas oil fractions, a narrower boiling range may be desirable. For such gas oil fractions, at least 90 wt % of the fraction, or at least 95 wt %, can have a boiling point in the range of ˜650° F. (˜343° C.) to ˜1000° F. (˜538° C.), or ˜650° F. (˜343° C.) to ˜900° F. (˜482° C.). A residual fuel product can have a boiling range that may vary and/or overlap with one or more of the above boiling ranges. A residual marine fuel product can satisfy the requirements specified in ISO 8217, Table 2.

A method of characterizing the solubility properties of a petroleum fraction can correspond to the toluene equivalence (TE) of a fraction, based on the toluene equivalence test as described for example in U.S. Pat. No. 5,871,634 (incorporated herein by reference with regard to the definition for toluene equivalence, solubility number (S_{BN}), and insolubility number (I_{N})). The calculated carbon aromaticity index (CCAI) can be determined according to ISO 8217. BMCI can refer to the Bureau of Mines Correlation Index, as commonly used by those of skill in the art.

Briefly, the determination of the Insolubility Number (I_{N}) and the Solubility Blending Number (S_{BN}) for a petroleum oil (containing n-theptane insoluble asphaltenes) requires testing the solubility of the oil in test liquid mixtures at the minimum of two volume ratios of oil to test liquid mixture. The test liquid mixtures are prepared by mixing two liquids in various proportions. One liquid is nonpolar and a solvent for the asphaltenes in the oil while the other liquid is nonpolar and a nonsolvent for the asphaltenes in the oil. Since asphaltenes are defined as being insoluble in n-heptane and soluble in toluene it is most convenient to select the same n-heptane as the nonsolvent for the test liquid and toluene as the solvent for the test liquid. Although the selection of many other test nonsolvents and test solvents can be made, there use provides not better definition of the preferred oil blending process than the use of n-heptane and toluene described here.

A convenient volume ratio of oil to test liquid mixture is selected for the first test, for instance, 1 ml. of oil to 5 ml. of test liquid mixture. Then various mixtures of the test liquid mixture are prepared by blending n-heptane and toluene in various known proportions. Each of these is mixed with the oil at the selected volume ratio of oil to test liquid mixture. Then it is determined for each of these if the asphaltenes are soluble or insoluble. Any convenient method might be used. One possibility is to observe a. drop of the blend of test liquid mixture and oil between a glass slide and a glass cover slip using transmitted light with an optical microscope at a magnification of from 50 to 600x. If the asphaltenes are in solution, few, if any, dark particles will be observed. If the asphaltenes are insoluble, many dark, usually brownish, particles, usually 0.5 to 10 microns in size, will be observed. Another possible method is to put a drop of the blend of test liquid mixture and oil on a piece of filter paper and let dry. If the asphaltenes are insoluble, a dark ring or circle will be seen about the center of the yellow-brown spot made by the oil. If the asphaltenes are soluble, the color of the spot made by the oil will be relatively uniform in color. The results of blending oil with all of the test liquid mixtures are ordered according to increasing percent toluene in the test liquid mixture. The desired value will be between the minimum percent toluene that dissolves asphaltenes and the maximum percent toluene that precipitates asphaltenes. More test liquid mixtures are prepared with percent toluene in between these limits, blended with oil at the selected oil to test liquid mixture volume ratio, and determined if the asphaltenes are soluble or insoluble. The desired value will be between the minimum percent toluene that dissolves asphaltenes and the maximum percent toluene that precipitates asphaltenes. This process is continued until the desired value is determined within the desired accuracy. Finally, the desired value is taken to be the mean of the minimum percent toluene that dissolves asphaltenes and the maximum percent toluene that precipitates asphaltenes. This is the first datum point, T₁, at the selected oil to test liquid mixture volume ratio, R₁. This test is called the toluene equivalence test.

The second datum point can be determined by the same process as the first datum point, only by selecting a different oil to test liquid mixture volume ratio. Alternatively, a percent toluene below that determined for the first datum point can be selected and that test liquid mixture can be added to a known volume of oil until asphaltenes just begin to precipitate. At that point the volume ratio of oil to test liquid mixture, R₂, at the selected percent toluene in the test liquid mixture, T₂, becomes the second datum point. Since the accuracy of the final numbers increase as the further apart the second datum point is from the first datum point, the preferred test liquid mixture for determining the second datum point is 0% toluene or 100% n-heptane. This test is called the heptane dilution test.

The Insolubility Number, I_{N}, is given by:

$${I}_{N} = {T}_{2} - [ \frac{{T}_{2} - {T}_{1}}{{R}_{2} - {R}_{1}} ] {R}_{2} \qquad ( 1 )$$

and the Solubility Blending Number, S_{BN}, is given by:

$${S}_{BN} = {I}_{N} [ 1 + \frac{1}{{R}_{2}} ] - \frac{{T}_{2}}{{R}_{2}} \qquad ( 2 )$$

It is noted that additional procedures are available, such as those specified in U.S. Pat. No. 5,871,634, for determination of S_{BN} for oil samples that do not contain asphaltenes.

In this discussion and the claims below, the effluent from a processing stage may be characterized in part by characterizing a fraction of the products. For example, the effluent from a processing stage may be characterized in part based on a portion of the effluent that can be converted into a liquid product. This can correspond to a C₃+ portion of an effluent, and may also be referred to as a total liquid product. As another example, the effluent from a processing stage may be characterized in part based on another portion of the effluent, such as a C₅+ portion or a C₆+ portion. In this discussion, a portion corresponding to a “Cₓ+” portion can be, as understood by those of skill in the art, a portion with an initial boiling point that roughly corresponds to the boiling point for an aliphatic hydrocarbon containing “x” carbons.

In this discussion, a low sulfur fuel oil can correspond to a fuel oil containing about 0.5 wt % or less of sulfur. An ultra low sulfur fuel oil, which can also be referred to as an Emission Control Area fuel, can correspond to a fuel oil containing about 0.1 wt % or less of sulfur. A low sulfur diesel can correspond to a diesel fuel containing about 500 wppm or less of sulfur. An ultra low sulfur diesel can correspond to a diesel fuel containing about 15 wppm or less of sulfur, or about 10 wppm or less.

In this discussion and the claims below, references to a wt % or a vol % refer to the weight of the feed or fraction being described, unless otherwise specified.

### Feedstock—Blend of Catalytic Slurry Oil and Steam Cracker Tar

In some aspects, a feedstock that includes a blend of both a portion of catalytic slurry oil and a portion of steam cracker tar can be treated to remove particles and then hydroprocessed, such as by hydrotreating in a fixed bed reactor. The properties of such a blended feedstock can vary somewhat depending on the relative amounts of steam cracker tar and catalytic slurry oil. Additionally or alternately, catalytic slurry oil and/or steam cracker tar can be used as a high solvency aromatic co-feed for slurry hydroprocessing of deasphalter residue or rock.

Fluid catalytic cracking (FCC) processes can commonly be used in refineries to increase the amount of fuels that can be generated from a feedstock. Because FCC processes do not typically involve addition of hydrogen to the reaction environment, FCC processes can be useful for conversion of higher boiling fractions to naphtha and/or distillate boiling range products at a lower cost than hydroprocessing. However, such higher boiling fractions can often contain multi-ring aromatic compounds that are not readily converted, in the absence of additional hydrogen, by the medium pore or large pore molecular sieves typically used in FCC processes. As a result, FCC processes can often generate a bottoms fraction that can be highly aromatic in nature. The bottoms fraction may also contain catalyst fines generated from the fluidized bed of catalyst during the FCC process. This type of FCC bottoms fraction may be referred to as a catalytic slurry oil or main column bottoms.

Typically the cut point for forming a catalytic slurry oil can be at least about 650° F. (˜343° C.). As a result, a catalytic slurry oil can have a T5 distillation (boiling) point or a T10 distillation point of at least about 650° F. (˜343° C.), as measured according to ASTM D2887. In some aspects the D2887 10% distillation point can be greater, such as at least about 675° F. (˜357° C.), or at least about 700° F. (˜371° C.). In some aspects, a broader boiling range portion of FCC products can be used as a feed (e.g., a 350° F.+/˜177° C.+ boiling range fraction of FCC liquid product), where the broader boiling range portion includes a 650° F.+(˜343° C.+) fraction that corresponds to a catalytic slurry oil. The catalytic slurry oil (650° F.+/˜343° C.+) fraction of the feed does not necessarily have to represent a “bottoms” fraction from an FCC process, so long as the catalytic slurry oil portion comprises one or more of the other feed characteristics described herein.

In addition to and/or as an alternative to initial boiling points, T5 distillation point, and/or T10 distillation points, other distillation points may be useful in characterizing a feedstock. For example, a feedstock can be characterized based on the portion of the feedstock that boils above 1050° F. (˜566° C.). In some aspects, a feedstock (or alternatively a 650° F.+/˜343° C.+ portion of a feedstock) can have an ASTM D2887 T95 distillation point of 1050° F. (˜566° C.) or greater, or a T90 distillation point of 1050° F. (˜566° C.) or greater. In the claims below, references to boiling points, distillation points, and/or fractional weight boiling points/distillation points are with reference to ASTM D2887. If a feedstock or other sample contains components that are not suitable for characterization using D2887, ASTM D7169 may be used instead.

Density, or weight per volume, of the catalytic slurry oil can also be characterized. In various aspects, the density of the catalytic slurry oil (or alternatively a 650° F.+ portion of a feedstock) can be at least about 1.06 g/cc, or at least about 1.08 g/cc, or at least about 1.10 g/cc. The density of the catalytic slurry oil can provide an indication of the amount of heavy aromatic cores that are present within the catalytic slurry oil. A lower density catalytic slurry oil feed can in some instances correspond to a feed that may have a greater expectation of being suitable for hydrotreatment without substantial and/or rapid coke formation.

Catalytic slurry oils can also include n-heptane insoluble (NHI) or asphaltenes. In some aspects, the catalytic slurry oil feed (or alternatively a 650° F.+ portion of a feed) can contain at least about 3 wt % of n-heptane asphaltenes, or at least about 5 wt %, and/or up to about 10 wt %. Another option for characterizing the heavy components of a catalytic slurry oil can be based on the amount of micro carbon residue (MCR) in the feed. In various aspects, the amount of MCR in the catalytic slurry oil feed (or alternatively a 650° F.+ portion of a feed) can be at least about 5 wt %, or at least about 8 wt %, or at least about 10 wt %, and/or up to about 16 wt %.

Based on the content of NHI and/or MCR in a catalytic slurry oil feed, the insolubility number (I_{N}) for such a feed can be at least about 60, or at least about 70, or at least about 80, or at least about 90. Additionally or alternately, the I_{N} for such a feed can be about 140 or less, or about 120 or less, or about 110 or less, or about 100 or less, or about 90 or less, or about 80 or less. It is noted that each lower bound noted above for I_{N} is explicitly contemplated in conjunction with each upper bound noted above for I_{N}. Additionally or alternately, each lower bound noted above for I_{N} is explicitly contemplated in conjunction with each lower and/or upper bound noted above for NHI and/or MCR.

“Tar” or steam cracker tar (SCT) as used herein is also referred to in the art as “pyrolysis fuel oil”. The terms can be used interchangeably herein. The tar will typically be obtained from the first fractionator downstream from a steam cracker (pyrolysis furnace) as the bottoms product of the fractionator, nominally having a boiling point of at least about 550° F.+(˜288° C+). Boiling points and/or fractional weight distillation points can be determined by, for example, ASTM D2892. Alternatively, SCT can have a T5 boiling point (temperature at which 5 wt % will boil off) of at least about 550° F. (˜288° C.). The final boiling point of SCT can be dependent on the nature of the initial pyrolysis feed and/or the pyrolysis conditions, and typically can be about 1450° F. (˜788° C.) or less.

Optionally, the feed can also include a flux for the steam cracker tar, such as a flux to improve the flow properties of the steam cracker tar. Examples of suitable flux for a steam cracker tar fraction can include, but are not limited to, steam cracker gas oil and other types of atmospheric or vacuum gas oil boiling range fractions. Thus, a flux can correspond to a fraction with a T5 boiling point of at least 343° C. and/or a T95 boiling point of 593° C. or less. Preferred fluxes are highly aromatic, e.g. steam cracker gasoil, LCCO, heavy FCC naphtha, and heavy reformate. Similar to MCB and steam cracker tar feedstocks, aromatic fluxes can have high SBN.

A blended feed of catalytic slurry oil and SCT can have a relatively low hydrogen content compared to heavy oil fractions that are typically processed in a refinery setting. In some aspects, a blended feed can have a hydrogen content of about 8.0 wt % or less, about 7.5 wt % or less, or about 7.0 wt % or less, or about 6.5 wt % or less. In particular, a blended feed can have a hydrogen content of about 5.5 wt % to about 8.0 wt %, or about 6.0 wt % to about 7.5 wt %. Additionally or alternately, a blended feed can have a micro carbon residue (or alternatively Conradson Carbon Residue) of at least about 10 wt %, or at least about 15 wt %, or at least about 20 wt %, such as up to about 40 wt % or more. In the claims below, ASTM D4530 can be used to determine carbon residue.

A feed including catalytic slurry oil and/or SCT can also be highly aromatic in nature. In some aspects, the paraffin content of a feed can be about 2.0 wt % or less, or about 1.0 wt % or less, such as having substantially no paraffin content. In some aspects, the naphthene content of a feed can also be about 10 wt % or less or about 5.0 wt % or less. In still other aspects, the combined paraffin and naphthene content of a feed can be about 10 wt % or less. With regard to aromatics, at least about 65 wt % of the feed can be aromatics, as determined by ¹³C-NMR, or at least about 75 wt %. For example, the aromatics can be about 65 wt % to about 90 wt %, or about 65 wt % to 85 wt %, or about 70 wt % to about 90 wt %. In particular, the greater-than-3-ring aromatics content (i.e., 4+ ring aromatics) can be about 45 wt % to about 90 wt %, or about 50 wt % to about 75 wt %, or about 50 wt % to about 70 wt %. Additionally or alternately, at least about 30 wt % of a blended feed can correspond to greater-than-4-ring aromatics (i.e., 5+ ring aromatics), or at least 40 wt %. In particular, the greater-than-4-ring aromatics content can be about 30 wt % to about 60 wt %, or about 40 wt % to about 55 wt %, or about 40 wt % to about 50 wt %. Additionally or alternately, the 1-ring aromatic content can be about 15 wt % or less, or about 10 wt % or less, or about 5 wt % or less, such as down to about 0.1 wt %. In the claims below, references to aromatic weight percentages can be determined using ¹³C-NMR.

Due to the low hydrogen content and/or highly aromatic nature of SCT, the solubility number (S_{BN}) and insolubility number (I_{N}) of SCT can be relatively high. SCT can have a S_{BN} of at least about 100, and in particular about 120 to about 230, or about 150 to about 230, or about 180 to about 220. Additionally or alternately, SCT can have an I_{N} of about 70 to about 150, or about 100 to about 140, or about 80 to about 140. Further additionally or alternately, the difference between S_{BN} and I_{N} for the SCT can be at least about 30, or at least about 40, or at least about 50, such as up to about 150.

Without being bound by any particular theory, it is believed that the high S_{BN} content of catalytic slurry oil can allow SCT to be blended with catalytic slurry oil to make a suitable feed for fixed bed hydroprocessing. Based on the content of NHI and/or MCR in a catalytic slurry oil feed, the insolubility number (I_{N}) for such a feed can be at least about 60, such as at least about 70, at least about 80, or at least about 90. Additionally or alternately, the I_{N} for such a feed can be about 140 or less, such as about 130 or less, about 120 or less, about 110 or less, about 100 or less, about 90 or less, or about 80 or less. Each lower bound noted above for I_{N} can be explicitly contemplated in conjunction with each upper bound noted above for I_{N}. In particular, the I_{N} for a catalytic slurry oil feed can be about 60 to about 140, or about 60 to about 120, or about 80 to about 140.

A blended feed of catalytic slurry oil and SCT can also have a higher density than many types of crude or refinery fractions. In various aspects, a blended feed can have a density at 15° C. of about 1.08 g/cm³ to about 1.20 g/cm³, or 1.10 g/cm³ to 1.18 g/cm³. By contrast, many types of vacuum resid fractions can have a density of about 1.05 g/cm³ or less. Additionally or alternately, density (or weight per volume) of the heavy hydrocarbon can be determined according to ASTM D287-92 (2006) Standard Test Method for API Gravity of Crude Petroleum and Petroleum Products (Hydrometer Method), which characterizes density in terms of API gravity. In general, the higher the API gravity, the less dense the oil. The units for API gravity are degrees, although API values can often be reported without the associated unit. In various aspects, the API gravity of a blended feed (including any optional flux) can be 7 or less, or 5 or less, or 0 or less, such as down to about −15 or lower.

Contaminants such as nitrogen and sulfur are typically found in both catalytic slurry oil and SCT, often in organically-bound form. Nitrogen content can range from about 50 wppm to about 10,000 wppm elemental nitrogen or more, based on total weight of a blended feed. Sulfur content can range from about 0.1 wt % to about 10 wt %, based on total weight of a blended feed. In particular, the sulfur content can be about 0.1 wt % to about 10 wt %, or 1.0 wt % to about 10 wt %, or about 2.0 wt % to about 6.0 wt %.

As an example, SCT can be obtained as a product of a pyrolysis furnace wherein additional products include a vapor phase including ethylene, propylene, butenes, and a liquid phase comprising C₅₊ species, having a liquid product distilled in a primary fractionation step to yield an overheads comprising steam-cracked naphtha fraction (e.g., C₅-C₁₀ species) and steam cracked gas oil (SCGO) fraction (i.e., a boiling range of about 400 to 550° F., or ˜204 to ˜288° C., e.g., C₁₀-C₁₅/C₁₇ species), and a bottoms fraction comprising SCT and having a boiling range above about 550° F. (˜288° C.), e.g., C₁₅/C₁₇₊ species.

The term “asphaltene” is well-known in the art and generally refers to the material obtainable from crude oil and having an initial boiling point above 1200° F. (i.e., 1200° F.+ or ˜650° C.+ material) and which is insoluble in straight chain alkanes such as hexane and heptanes, i.e., paraffinic solvents. Asphaltenes are high molecular weight, complex aromatic ring structures and may exist as colloidal dispersions. They are soluble in aromatic solvents like xylene and toluene. Asphaltene content can be measured by various techniques known to those of skill in the art, e.g., ASTM D3279. In various aspects, SCT can have an n-heptane insoluble asphaltene content of at least about 5 wt %, or at least about 10 wt %, or at least about 15 wt %, such as up to about 40 wt %. Catalytic slurry oils can also include asphaltenes, such as asphaltenes that correspond to n-heptane insolubles. In some aspects, the catalytic slurry oil feed (or alternatively a ˜650° F.+/˜343° C.+ portion of a feed) can contain at least about 1.0 wt % of n-heptane insolubles or asphaltenes, or at least about 2.0 wt %, or at least about 3.0 wt %, or at least about 5.0 wt %, such as up to about 10 wt % or more. In particular, the catalytic slurry oil feed (or alternatively a ˜343° C.+ portion of a feed) can contain about 1.0 wt % to about 10 wt % of n-heptane insolubles or asphaltenes, or about 2.0 wt % to about 10 wt %, or about 3.0 wt % to about 10 wt %. Another option for characterizing the heavy components of a catalytic slurry oil can be based on the amount of micro carbon residue (MCR) in the feed. In various aspects, the amount of MCR in the catalytic slurry oil feed (or alternatively a ˜343° C.+ portion of a feed) can be at least about 3 wt %, or at least about 5 wt %, or at least about 10 wt %, such as up to about 15 wt % or more.

In general the operating conditions of a pyrolysis furnace for making a side product of SCT, which may be a typical pyrolysis furnace such as known per se in the art, can be determined by one of ordinary skill in the art in possession of the present disclosure without more than routine experimentation. Typical conditions will include a radiant outlet temperature of between 760-880° C., a cracking residence time period of 0.01 to 1 sec, and a steam dilution of 0.2 to 4.0 kg steam per kg hydrocarbon.

In general, a catalytic slurry oil used as a feed for the various processes described herein can correspond to a product from FCC processing. In particular, a catalytic slurry oil can correspond to a bottoms fraction and/or other fraction having a boiling range greater than a typical light cycle oil from an FCC process.

The properties of catalytic slurry oils suitable for use in some aspects are described above. In order to generate such suitable catalytic slurry oils, the FCC process used for generation of the catalytic slurry oil can be characterized based on the feed delivered to the FCC process. For example, performing an FCC process on a light feed, such as a feed that does not contain NHI or MCR components, can tend to result in an FCC bottoms product with an I_{N} of less than about 50. Such an FCC bottoms product can be blended with other feeds for hydroprocessing via conventional techniques. By contrast, the processes described herein can provide advantages for processing of FCC fractions (such as bottoms fractions) that have an I_{N} of greater than about 50 (such as up to about 200 or more), for example about 60 to 140, or about 70 to about 130.

Particle Removal from Blends of Catalytic Slurry Oil and Steam Cracker Tar

A number of difficulties in processing of feeds containing steam cracker tar can be related to the presence of coke fines. Coke fines can correspond to particles with sizes from a few microns to hundreds of microns. Steam cracker tar can also contain solvated precursors for forming additional coke fines. If a feed containing steam cracker tar is filtered or otherwise processed to remove coke fines, the precursor compounds in solution can precipitate to form additional coke fines. This can pose difficulties when attempting to process steam cracker tar under conventional conditions, as even if the coke fines initially present in a steam cracker tar fraction are removed, additional coke fines can form between filtration and processing in a fixed bed reactor. The coke fines can be of a sufficient size to cause plugging of the catalyst bed in a fixed bed reactor, leading to rapid reduction in the ability to effectively process a feed.

As noted above, a catalytic slurry oil fraction can initially contain catalyst fines. The catalyst fines in a catalytic slurry oil can optionally be removed prior to forming a blend of catalytic slurry oil and steam cracker tar. If catalyst fines are present in catalytic slurry oil when forming a blend with steam cracker tar, such catalyst fines can be removed by the techniques described herein for removing coke fines from the steam cracker tar portion of the blend.

Prior to filtration and/or other separation of particles from a blended feed of steam cracker tar and catalytic slurry oil, the blended feed can include at least about 100 wppm of particles having a particle size of 25 μm or greater, or at least about 200 wppm, or at least about 500 wppm. Additionally or alternately, the blended feed can include at least about 500 wppm of total particles, or at least about 1000 wppm, or at least about 2000 wppm. After separation to remove particles, a first separation effluent corresponding to a reduced particle content blended feed can be formed, the reduced particle content blended feed having a total particle content of less than about 500 wppm, or less than about 100 wppm. At least a second effluent can also be formed that includes at least about 200 wppm of particles having a particle size of 25 μm or greater, or at least about 500 wppm, such as up to about 5000 wppm or more.

In some aspects, coke fines, catalyst fines, and/or other particles in a blend of catalytic slurry oil and steam cracker tar can be removed using physical filtration based on particle size. This can correspond to passing the blended feed through a filter to form a permeate with a reduced particle content and a retentate enriched in particles. While this is potentially effective, it can be difficult to implement on a commercial scale, such as due to difficulties in maintaining a desired flow rate across a filter (or filters) and/or due to difficulties in having to take filter(s) off-line to allow for regeneration and maintenance.

In various aspects, an improved method of removing particles from a blended feed can correspond to removing a portion of particles from the blended feed by settling, followed by using electrostatic filtration to remove additional particles.

Settling can provide a convenient method for removing larger particles from a feed. During a settling process, the blended feed can be held in a settling tank or other vessel for a period of time. This time period can be referred to as a settling time. The blended feed can be at a settling temperature during the settling time. While any convenient settling temperature can potentially be used (such as a temperature from about 20° C. to about 200° C.), a temperature of about 100° C. or greater (such as at least 105° C., or at least 110° C.) can be beneficial for allowing the viscosity of the blended feed to be low enough to facilitate settling. Additionally or alternately, the settling temperature can be about 200° C. or less, or about 150° C. or less, or about 140° C. or less. In particular, the settling temperature can be about 100° C. to about 200° C., or about 105° C. to about 150° C., or about 110° C. to about 140° C. The upper end of the settling temperature can be less important, and temperatures of still greater than 200° C. may also be suitable. However, unless the blended feed is already at an elevated temperature for another reason, increasing the settling temperature to values greater than about 150° C. can provide a reduced or minimized marginal benefit for the settling process while requiring substantial additional amount of energy to maintain the temperature during the settling time.

After the settling time, the particles can be concentrated in a lower portion of the settling tank. The blended feed including a portion of catalytic slurry oil and a portion of steam cracker tar can be removed from the upper portion of the settling tank while leaving the particle enriched bottoms in the tank. The settling process can be suitable for reducing the concentration of particles having a particle size of about 25 μm or greater from the blended feed.

After removing the larger particles from the blended feed, the blended feed can then be passed into an electrostatic separator. An example of a suitable electrostatic separator can be a Gulftronic™ electrostatic separator available from General Atomic. An electrostatic separator can be suitable for removal of particles of a variety of sizes, including both larger particles as well as particles down to a size of about 5 μm or less or even smaller. However, it can be beneficial to remove larger particles using a settling process to reduce or minimize the accumulation of large particles in an electrostatic separator. This can reduce the amount of time required for flush and regeneration of an electrostatic separator.

In an electrostatic separator, dielectric beads within the separator can be charged to polarize the dielectric beads. A fluid containing particles for removal can then be passed into the electrostatic separator. The particles can be attracted to the dielectric beads, allowing for particle removal. After a period of time, the electrostatic separator can be flushed to allow any accumulated particles in the separator to be removed.

In various aspects, an electrostatic separator can be used in combination with a settling tank for particle removal. Performing electrostatic separation on an blended feed effluent from a settling tank can allow for reduction of the number of particles in a blended feed to about 500 wppm or less, or about 100 wppm or less, or about 50 wppm or less, such as down to about 20 wppm or possibly lower. In particular, the concentration of particles in the blended feed after electrostatic separation can be about 0 wppm to about 500 wppm, or about 0 wppm to about 100 wppm, or about 0 wppm to about 50 wppm, or about 1 wppm to about 20 wppm. In some aspects, a single electrostatic separation stage can be used to reduce the concentration of particles in the blended feed to a desired level. In some aspects, two or more electrostatic separation stages in series can be used to achieve a target particle concentration.

In an electrostatic separation stage, a plurality of electrostatic separators can be arranged in parallel. In addition to allowing for processing of a larger volume of feed at a single time, parallel operation can also allow a first group of one or more electrostatic separators to operate in separation mode while a second group of one or more electrostatic separators can be in a flush or regeneration mode. More generally, any convenient number of staggered cycles can be used to allow for continuous particle removal from a feed while allowing for flushing of separators to remove accumulated particles.

A cycle length for an individual electrostatic separator unit can correspond to any convenient cycle length based on the flow rate of feed into the unit and the density of suspended solids (i.e., particles) in the feed. Typical cycles can include a separation portion of a cycle having a length of about 1 minute to about 30 minutes and a flush or regeneration portion of about 1 minute to about 30 minutes.

### Fixed Bed Hydrotreatment

After removal of fines, a blended feed including a portion of catalytic slurry oil and a portion of steam cracker tar can be hydrotreated. An example of a suitable type of hydrotreatment can be hydrotreatment under trickle bed conditions or other fixed bed conditions.

It is noted that both steam cracker tar and typical catalytic slurry oils can correspond to feeds having an I_{N} Conventionally, feeds having an I_{N} of greater than about 50 have been viewed as unsuitable for fixed bed (such as trickle bed) hydroprocessing. This conventional view can be due to the belief that feeds with an I_{N} of greater than about 50 are likely to cause substantial formation of coke within a reactor, leading to rapid plugging of a fixed reactor bed. Instead of using a fixed bed reactor, feeds with a high I_{N} value are conventionally processed using other types of reactors that can allow for regeneration of catalyst during processing, such as a fluidized bed reactor or an ebullating bed reactor. Alternatively, during conventional use of a fixed bed catalyst for processing of a high I_{N} feed, the conditions can be conventionally selected to achieve a low amount of conversion in the feed relative to a conversion temperature of ˜1050° F. (˜566° C.), such as less than about 30% to about 50% conversion. Based on conventional understanding, performing a limited amount of conversion on a high I_{N} feed can be required to avoid rapid precipitation and/or coke formation within a fixed bed reactor.

In various aspects, a blended feed including a portion of a catalytic slurry oil and a portion of steam cracker tar can be hydrotreated under effective hydrotreating conditions to form a hydrotreated effluent. Optionally, the effective hydrotreating conditions can be selected to allow for reduction of the n-heptane asphaltene content of the hydrotreated effluent to less than about 1.0 wt %, or less than about 0.5 wt %, or less than about 0.1 wt %, and optionally down to substantially no remaining n-heptane asphaltenes. Additionally or alternately, the effective hydrotreating conditions can optionally be selected to allow for reduction of the micro carbon residue content of the hydrotreated effluent to less than about 2.5 wt %, or less than about 1.0 wt %, or less than about 0.5 wt %, or less than about 0.1 wt %, and optionally down to substantially no remaining micro carbon residue.

Additionally or alternately, in various aspects, the combination of processing conditions can be selected to achieve a desired level of conversion of a feedstock, such as conversion relative to a conversion temperature of ˜700° F. (˜371° C.). For example, the process conditions can be selected to achieve at least about 40% conversion of the ˜700° F.+(˜371° C.+) portion of a feedstock, such as at least about 50 wt %, or at least about 60 wt %, or at least about 70 wt %. Additionally or alternately, the conversion percentage can be about 80 wt % or less, or about 75 wt % or less, or about 70 wt % or less. In particular, the amount of conversion relative to 371° C. can be about 40 wt % to about 80 wt %, or about 50 wt % to about 70 wt %, or about 60 wt % to about 80 wt %. Optionally, the amount of conversion of 1050° F.+(˜566° C.+) components to 1050° F.−(˜566° C.-) components can also be controlled. In some optional aspects, at least about 20 wt % of 1050° F.+(˜566° C.+) components can be converted to 1050° F.−(˜566° C.−) components, or at least about 50 wt %, or at least about 70 wt %, or at least about 80 wt %, such as up to substantially complete conversion of ˜566° C.+ components of the blended feed. In particular, the amount of conversion of ˜566° C.+ components to ˜566° C.− components can be about 20 wt % to about 100 wt %, or about 50 wt % to about 100 wt %, or about 70 wt % to about 100 wt %.

Hydroprocessing (such as hydrotreating) can be carried out in the presence of hydrogen. A hydrogen stream can be fed or injected into a vessel or reaction zone or hydroprocessing zone corresponding to the location of a hydroprocessing catalyst. Hydrogen, contained in a hydrogen “treat gas,” can be provided to the reaction zone. Treat gas, as referred to herein, can be either pure hydrogen or a hydrogen-containing gas stream containing hydrogen in an amount in excess of that needed for the intended reaction(s). Treat gas can optionally include one or more other gasses (e.g., nitrogen and light hydrocarbons such as methane) that do not adversely interfere with or affect either the reactions or the products. Impurities, such as H₂S and NH₃ are undesirable and can typically be removed from the treat gas before conducting the treat gas to the reactor. In aspects where the treat gas stream can differ from a stream that substantially consists of hydrogen (i..e, at least about 99 vol % hydrogen), the treat gas stream introduced into a reaction stage can contain at least about 50 vol %, or at least about 75 vol % hydrogen, or at least about 90 vol % hydrogen.

During hydrotreatment, a feedstream can be contacted with a hydrotreating catalyst under effective hydrotreating conditions which include temperatures in the range of about 450° F. to about 800° F. (˜232° C. to ˜427° C.), or about 550° F. to about 750° F. (˜288° C. to ˜399° C.); pressures in the range of about 1.5 MPag to about 41.6 MPag (-200 to ˜6000 psig), or about 2.9 MPag to about 20.8 MPag (˜400 to ˜3000 psig); a liquid hourly space velocity (LHSV) of from about 0.1 to about 10 hr⁻¹, or about 0.1 to 5 hr⁻¹; and a hydrogen treat gas rate of from about 430 to about 2600 Nm³/m³ (˜2500 to ˜15000 SCF/bbl), or about 850 to about 1700 Nm³/m³ (˜5000 to ˜10000 SCF/bbl).

In an aspect, the hydrotreating step may comprise at least one hydrotreating reactor, and optionally may comprise two or more hydrotreating reactors arranged in series flow. Optionally, an initial bed in a hydrotreating reactor and/or an initial reactor in a sequence of reactors can correspond to a guard bed or guard reactor. A guard bed or guard reactor can be operated at lower severity conditions and/or can include a lower activity hydrotreating catalyst. This can assist with managing heat release and/or can further assist with mitigating reactor fouling. A vapor separation drum can optionally be included after each hydrotreating reactor to remove vapor phase products from the reactor effluent(s). The vapor phase products can include hydrogen, H₂S, NH₃, and hydrocarbons containing four (4) or less carbon atoms (i.e., “C₄-hydrocarbons”). Optionally, a portion of the C₃ and/or C₄ products can be cooled to form liquid products. The effective hydrotreating conditions can be suitable for removal of at least about 70 wt %, or at least about 80 wt %, or at least about 90 wt % of the sulfur content in the feedstream from the resulting liquid products. Additionally or alternately, at least about 50 wt %, or at least about 75 wt % of the nitrogen content in the feedstream can be removed from the resulting liquid products. In some aspects, the final liquid product from the hydrotreating unit can contain less than about 1000 ppmw sulfur, or less than about 500 ppmw sulfur, or less than about 300 ppmw sulfur, or less than about 100 ppmw sulfur.

The effective hydrotreating conditions can optionally be suitable for incorporation of a substantial amount of additional hydrogen into the hydrotreated effluent. During hydrotreatment in such optional aspects, the consumption of hydrogen by the feed in order to form the hydrotreated effluent can correspond to at least about 1500 SCF/bbl (˜260 Nm³/m³) of hydrogen, or at least about 1700 SCF/bbl (˜290 Nm³/m³), or at least about 2000 SCF/bbl (˜330 Nm³/m³), or at least about 2200 SCF/bbl (˜370 Nm³/m³), such as up to about 5000 SCF/bbl (˜850 Nm³/m³) or more. In particular, the consumption of hydrogen can be about 1500 SCF/bbl (˜260 Nm³/m³) to about 5000 SCF/bbl (˜850 Nm³/m³), or about 2000 SCF/bbl (˜340 Nm³/m³) to about 5000 SCF/bbl (˜850 Nm³/m³), or about 2200 SCF/bbl (˜370 Nm³/m³) to about 5000 SCF/bbl (˜850 Nm³/m³).

Hydrotreating catalysts suitable for use herein can include those containing at least one Group VIA metal and at least one Group VIII metal, including mixtures thereof. Examples of suitable metals include Ni, W, Mo, Co and mixtures thereof, for example CoMo, NiMoW, NiMo, or NiW. These metals or mixtures of metals are typically present as oxides or sulfides on refractory metal oxide supports. The amount of metals for supported hydrotreating catalysts, either individually or in mixtures, can range from ˜0.5 to ˜35 wt %, based on the weight of the catalyst. Additionally or alternately, for mixtures of Group VIA and Group VIII metals, the Group VIII metals can be present in amounts of from ˜0.5 to ˜5 wt % based on catalyst, and the

Group VIA metals can be present in amounts of from 5 to 30 wt % based on the catalyst. A mixture of metals may also be present as a bulk metal catalyst wherein the amount of metal can comprise ˜30 wt % or greater, based on catalyst weight.

Suitable metal oxide supports for the hydrotreating catalysts include oxides such as silica, alumina, silica-alumina, titania, or zirconia. Examples of aluminas suitable for use as a support can include porous aluminas such as gamma or eta. In some aspects where the support can correspond to a porous metal oxide support, the catalyst can have an average pore size (as measured by nitrogen adsorption) of about 30 Å to about 1000 Å, or about 50 Å to about 500 Å, or about 60 Å to about 300 Å. Pore diameter can be determined, for example, according to ASTM Method D4284-07 Mercury Porosimetry. Additionally or alternately, the catalyst can have a surface area (as measured by the BET method) of about 100 to 350 m²/g, or about 150 to 250 m²/g. In some aspects, a supported hydrotreating catalyst can have the form of shaped extrudates. The extrudate diameters can range from 1/32nd to ⅛^{th} inch (˜0.7 to ˜3.0 mm), from 1/20^{th} to 1/10^{th} inch (˜1.3 to ˜2.5 mm), or from 1/20^{th} to 1/16^{th} inch (˜1.3 to ˜1.5 mm). The extrudates can be cylindrical or shaped. Non-limiting examples of extrudate shapes include trilobes and quadralobes.

In some optional aspects, one or more fractions of the hydrotreated feed, such as one or more 454° C.+ fractions, can be hydroprocessed a second time to produce twice-hydroprocessed fractions. During hydroprocessing in a second hydroprocessing stage or stages, a feedstream can be exposed to hydrotreating conditions, aromatic saturation conditions, or a combination thereof. Second stage hydrotreating conditions can include contacting a feed with with a hydrotreating catalyst under effective hydrotreating conditions which include temperatures in the range of about 600° F. to about 800° F. (˜316° C. to ˜427° C.), or about 680° F. to about 790° F. (˜360° C. to ˜421° C.); pressures in the range of about 13.8 MPag to about 34.4 MPag (˜2000 psig to ˜5000 psig), or about 20.8 MPag to about 27.6 MPag (˜3000 to ˜4500 psig); a liquid hourly space velocity (LHSV) of from about 0.1 to about 10 hr⁻¹, or about 0.1 to 5 hr⁻¹; and a hydrogen treat gas rate of from about 430 to about 2600 Nm³/m³ (˜2500 to ˜15000 SCF/bbl), or about 850 to about 1700 Nm³/m³ (˜5000 to ˜10000 SCF/bbl). The hydrotreating catalyst can be a hydrotreating catalyst as described above.

Aromatic saturation conditions in the second stage can be similar to the second stage hydrotreating conditions. In some aspects, the hydrotreating catalyst and aromatic saturation catalyst can correspond to a stacked bed of catalyst. The aromatic saturation catalyst can correspond to any convenient type of aromatic saturation catalyst.

Hydrofinishing and/or aromatic saturation catalysts can include catalysts containing Group VI metals, Group VIII metals, and mixtures thereof. In an embodiment, preferred metals include at least one metal sulfide having a strong hydrogenation function. In another embodiment, the hydrofinishing catalyst can include a Group VIII noble metal, such as Pt, Pd, or a combination thereof. The mixture of metals may also be present as bulk metal catalysts wherein the amount of metal is about 30 wt. % or greater based on catalyst. Suitable metal oxide supports include low acidic oxides such as silica, alumina, silica-aluminas or titania, preferably alumina. The preferred hydrofinishing catalysts for aromatic saturation will comprise at least one metal having relatively strong hydrogenation function on a porous support. Typical support materials include amorphous or crystalline oxide materials such as alumina, silica, and silica-alumina. The support materials may also be modified, such as by halogenation, or in particular fluorination. Optionally, a hydrofinishing catalyst can include a hydrogenation metal supported on a crystalline material belonging to the M41S class or family of catalysts. The M41S family of catalysts are mesoporous materials having high silica content. Examples include MCM-41, MCM-48 and MCM-50.

### Additional Hydroprocessing of Feed

In various aspects, catalytic dewaxing can be included as part of a second or subsequent processing stage. Preferably, the dewaxing catalysts according to the invention are zeolites (and/or zeolitic crystals) that perform dewaxing primarily by isomerizing a hydrocarbon feedstock. More preferably, the catalysts are zeolites with a unidimensional pore structure.

Suitable catalysts include 10-member ring pore zeolites, such as EU-1, ZSM-35 (or ferrierite), ZSM-11, ZSM-57, NU-87, SAPO-11, and ZSM-22. Preferred materials are EU-2, EU-11, ZBM-30, ZSM-48, or ZSM-23. ZSM-48 can be most preferred. Note that a zeolite having the ZSM-23 structure with a silica to alumina ratio of from 20:1 to 40:1 can sometimes be referred to as SSZ-32. Other zeolitic crystals that are isostructural with the above materials include Theta-1, NU-10, EU-13, KZ-1, and NU-23.

In various aspects, the dewaxing catalysts can include a metal hydrogenation component. The metal hydrogenation component can typically be a Group 6 and/or a Group 8-10 metal. Preferably, the metal hydrogenation component comprises a Group 8-10 noble metal. Preferably, the metal hydrogenation component comprises Pt, Pd, or a mixture thereof In an alternative preferred embodiment, the metal hydrogenation component can be a combination of a non-noble Group 8-10 metal with a Group 6 metal. Suitable combinations can include Ni, Co, or Fe with Mo or W, preferably Ni with Mo or W.

The metal hydrogenation component may be added to the catalyst in any convenient manner. One technique for adding the metal hydrogenation component can be by incipient wetness. For example, after combining a zeolite and a binder, the combined zeolite and binder can be extruded into catalyst particles. These catalyst particles can then be exposed to a solution containing a suitable metal precursor. Alternatively, metal can be added to the catalyst by ion exchange, where a metal precursor can be added to a mixture of zeolite (or zeolite and binder) prior to extrusion.

The amount of metal in the catalyst can be at least ˜0.1 wt % based on catalyst, or at least ˜0.2 wt %, or at least ˜0.3 wt %, or at least ˜0.5 wt % based on catalyst. The amount of metal in the catalyst can be ˜20 wt % or less based on catalyst, or ˜10 wt % or less, or ˜5 wt % or less, or ˜3 wt % or less, or ˜1 wt % or less. For aspects where the metal comprises Pt, Pd, another Group 8-10 noble metal, or a combination thereof, the amount of metal can be from ˜0.1 to ˜5 wt %, preferably from ˜0.1 to ˜2 wt %, or ˜0.2 to ˜2 wt %, or ˜0.5 to 1.5 wt %. For aspects where the metal comprises a combination of a non-noble Group 8-10 metal with a Group 6 metal, the combined amount of metal can be from ˜0.5 wt % to ˜20 wt %, or ˜1 wt % to ˜15 wt %, or ˜2 wt % to ˜10 wt %.

Preferably, the dewaxing catalysts can be catalysts with a low ratio of silica to alumina. For example, for ZSM-48, the ratio of silica to alumina in the zeolite can be less than ˜200:1, such as less than ˜110:1, less than ˜100:1, less than 90:1, or less than 80:1. In particular, the ratio of silica to alumina can be ˜30:1 to ˜200:1, or ˜60:1 to ˜110:1, or ˜70:1 to ˜100:1.

The dewaxing catalysts can optionally include a binder. In some embodiments, the dewaxing catalysts used in process according to the invention are formulated using a low surface area binder, a low surface area binder represents a binder with a surface area of ˜100 m²/g or less, or ˜80 m²/g or less, or ˜70 m²/g or less, such as down to ˜40 m²/g or still lower.

Optionally, the binder and the zeolite particle size can be selected to provide a catalyst with a desired ratio of micropore surface area to total surface area. In dewaxing catalysts used according to the invention, the micropore surface area corresponds to surface area from the unidimensional pores of zeolites in the dewaxing catalyst. The total surface corresponds to the micropore surface area plus the external surface area. Any binder used in the catalyst will not contribute to the micropore surface area and will not significantly increase the total surface area of the catalyst. The external surface area can represent the balance of the surface area of the total catalyst minus the micropore surface area. Both the binder and zeolite can contribute to the value of the external surface area. Preferably, the ratio of micropore surface area to total surface area for a dewaxing catalyst can be equal to or greater than ˜25%.

A zeolite can be combined with binder in any convenient manner. For example, a bound catalyst can be produced by starting with powders of both the zeolite and binder, combining and mulling the powders with added water to form a mixture, and then extruding the mixture to produce a bound catalyst of a desired size. Extrusion aids can be used to modify the extrusion flow properties of the zeolite and binder mixture. The amount of framework alumina in the catalyst may range from ˜0.1 to ˜3.3 wt %, or ˜0.1 to ˜2.7 wt %, or ˜0.2 to ˜2.0 wt %, or ˜0.3 to ˜1.0 wt %.

In some embodiments, a binder composed of two or more metal oxides can be used. In such embodiments, the weight percentage of the low surface area binder can preferably be greater than the weight percentage of the higher surface area binder.

Optionally, if both metal oxides used for forming a mixed metal oxide binder have a sufficiently low surface area, the proportions of each metal oxide in the binder are less important.

When two or more metal oxides are used to form a binder, the two metal oxides can be incorporated into the catalyst by any convenient method. For example, one binder can be mixed with the zeolite during formation of the zeolite powder, such as during spray drying. The spray dried zeolite/binder powder can then be mixed with the second metal oxide binder prior to extrusion. In yet another aspect, the dewaxing catalyst can be self-bound and does not contain a binder. Process conditions in a catalytic dewaxing zone can include a temperature of ˜200 to ˜450° C., preferably ˜270 to ˜400° C., a hydrogen partial pressure of ˜1.8 to ˜34.6 mPa (˜250 to 5000 psi), preferably ˜4.8 to ˜20.8 mPa, a liquid hourly space velocity of ˜0.2 to ˜10 hr⁻¹, preferably ˜0.5 to ˜3.0 hr⁻¹, and a hydrogen treat gas rate of about 35 Nm³/m³ to about 1700 Nm³/m³ (˜200 to ˜10,000 SCF/bbl), preferably about 170 Nm³/m³ to about 850 Nm³/m³ (˜1000 to ˜5000 SCF/bbl).

Product Properties—Hydrotreated Effluent and FCC Products from CSO Processing

The intermediate and/or final products from processing of a blended feed of catalytic slurry oil and steam cracker tar can be characterized in various manners. One type of product that can be characterized can be the hydrotreated effluent derived from hydrotreatment of a blended feed. Additionally or alternately, the hydrotreated effluent derived from hydrotreatment of a blended feed may be fractionated into distillate and residual range portions. The distillate and/or residual range portions can be characterized.

After hydrotreatment, the liquid (C3+) portion of the hydrotreated effluent can have a volume of at least about 95% of the volume of the blended feed, or at least about 100% of the volume of the feed, or at least about 105%, or at least about 110%, such as up to about 150% of the volume. In particular, the yield of C₃+ liquid products can be about 95 vol % to about 150 vol %, or about 110 vol % to about 150 vol %. Optionally, the C₃ and C₄ hydrocarbons can be used, for example, to form liquefied propane or butane gas as a potential liquid product.

Therefore, the C₃+ portion of the effluent can be counted as the “liquid” portion of the effluent product, even though a portion of the compounds in the liquid portion of the hydrotreated effluent may exit the hydrotreatment reactor (or stage) as a gas phase at the exit temperature and pressure conditions for the reactor.

After hydrotreatment, the boiling range of the liquid (C3+) portion of the hydrotreated effluent can be characterized in various manners. In some aspects, the total liquid product can have a T50 distillation point of about 320° C. to about 400° C., or about 340° C. to about 390° C., or about 350° C. to about 380° C. In some aspects, the total liquid product can have a T90 distillation point of about 450° C. to about 525° C. In some aspects, the total liquid product can have a T10 distillation point of at least about 250° C., which can reflect the low amount of conversion that occurs during hydroprocessing of higher boiling compounds to C₃+ compounds with a boiling point below 200° C. In some aspects, the (weight) percentage of the liquid (C₃+) portion that comprises a distillation point greater than about ˜566° C. can be about 2 wt % or less, such as about 1.5 wt % or less, about 1.0 wt % or less, about 0.5 wt % or less, about 0.1 wt % or less, or about 0.05 wt % or less (i.e., substantially no compounds with a distillation point greater than about 1050° F./˜566° C.). Additionally or alternately, the (weight) percentage of the liquid portion that comprises a distillation point less than about ˜371° C. can be at least about 40 wt %, or at least about 50 wt %, or at least about 60 wt %, such as up to about 90 wt % or more.

The hydrotreated total liquid product and/or a portion of the hydrotreated product can have a favorable energy density. The energy content of the total liquid product and/or a portion of the total liquid product can be at least about 40.0 MJ/kg, such as at least about 40.5 MJ/kg, at least about 41.0 MJ/kg, at least about 41.5 MJ/kg, and/or about 43.0 MJ/kg or less, or about 42.5 MJ/kg or less. In particular, the energy density can be about 40.0 MJ/kg to about 43.0 MJ/kg, or about 41.0 MJ/kg to about 43.0 MJ/kg, or about 40.0 MJ/kg to about 41.5 MJ/kg. This favorable energy density can allow the total liquid product and/or a portion of the total liquid product to be added to various types of fuel products while maintaining the energy density of the fuel product.

In some aspects, the density (at 15° C.) of the liquid (C₃+) portion of the hydrotreated effluent can be about 1.05 g/cc or less, such as about 1.02 g/cc or less, about 1.00 g/cc or less, about 0.98 g/cc or less, about 0.96 g/cc or less, about 0.94 g/cc or less, about 0.92 g/cc or less, such as down to about 0.84 g/cc or lower. In particular, the density can be about 0.84 g/cc to about 1.02 g/cc, or about 0.92 g/cc to about 1.02 g/cc, or about 0.84 g/cc to about 1.00 g/cc. Additionally or alternately, the API gravity of the liquid portion of the hydrotreated effluent can be at least 0, or at least 5, or at least 10. In particular, the API gravity can be 5 to 25, or 7 to 15. In some aspects, the API gravity of the hydrotreated effluent can be increased relative to the API gravity of the blended feed. For example, the API gravity of the hydrotreated effluent (or the liquid portion thereof) can be at least 5 greater than the API gravity of the blended feed, or at least 10 greater, or at least 15 greater, such as up to 25 greater or more.

The sulfur content of the liquid (C3+) portion of the hydrotreated effluent can be about 5000 wppm or less, or about 3000 wppm or less, or about 2000 wppm or less, or about 1000 wppm or less, or about 700 wppm or less, or about 500 wppm or less, or about 300 wppm or less, or about 100 wppm or less, such as at least about 1 wppm. In particular, the sulfur content can be about 1 wppm to about 5000 wppm, or about 100 wppm to about 2000 wppm, or about 1 wppm to about 500 wppm.

The micro carbon residue of the liquid (C₃+) portion of the hydrotreated effluent can be about 4.0 wt % or less, or about 3.0 wt % or less, or about 2.5 wt % or less, or about 2.0 wt % or less, or about 1.0 wt % or less, or about 0.5 wt % or less, such as substantially complete removal of micro carbon residue. In particular, the micro carbon residue can be about 0 wt % to about 3.0 wt %, or about 0 wt % to about 2.0 wt %, or about 0 wt % to about 1.0 wt %.

The amount of n-heptane insolubles (NHI) in the liquid (C₃+) portion of the hydrotreated effluent, as determined by ASTM D3279, can be about 2.0 wt % or less, or about 1.5 wt % or less, or about 1.0 wt % or less, or about 0.5 wt % or less, or about 0.1 wt % or less, such as substantially complete removal of NHI.

The hydrogen content of the liquid (C3+) portion of the hydrotreated effluent can be at least about 9.5 wt %, or at least about 10.0 wt %, or at least about 10.5 wt %, or at least about 11.0 wt %, or at least about 11.5 wt %. In particular, the hydrogen content can be about 9.5 wt % to about 12.0 wt %, or about 10.5 wt % to about 12.0 wt %, or about 11.0 wt % to about 12.0 wt %.

The I_{N} of the liquid (C₃+) portion of the hydrotreated effluent can be about 40 or less, or about 30 or less, or about 20 or less, or about 10 or less, or about 5 or less, such as down to about 0.

In some aspects, the portion of the hydrotreated effluent having a boiling range/distillation point of less than about 700° F. (˜371° C.) can be used as a low sulfur fuel oil or blendstock for low sulfur fuel oil and/or can be further hydroprocessed (optionally with other distillate streams) to form ultra low sulfur naphtha and/or distillate (such as diesel) fuel products, such as ultra low sulfur fuels or blendstocks for ultra low sulfur fuels. The portion having a boiling range/distillation point of at least about 700° F. (˜71° C.) can be used as an ultra low sulfur fuel oil having a sulfur content of about 0.1 wt % or less or optionally blended with other distillate or fuel oil streams to form an ultra low sulfur fuel oil or a low sulfur fuel oil. In some aspects, at least a portion of the liquid hydrotreated effluent having a distillation point of at least about ˜71° C. can be used as a feed for FCC processing.

In some aspects, portions of the hydrotreated effluent can be used as fuel products and/or fuel blendstocks. One option can be to use the total liquid product from hydrotreatment as a blendstock for low sulfur fuel oil or ultra low sulfur fuel oil. The sulfur content of the hydrotreated product can be sufficiently low to allow for use as a blendstock to reduce the overall sulfur content of a fuel oil composition. Additionally, the hydrotreated product can have a sufficient content of aromatic compounds to be compatible for blending with a fuel oil. Further, the energy content of the hydrotreated effluent can be comparable to the energy content of a fuel oil.

Another option can be to use a bottoms portion of the total liquid product from hydrotreatment as a fuel oil blendstock. The bottoms portion can correspond to a portion defined based on a convenient distillation point, such as a cut point of about 550° F. (288° C.) to about 750° F. (399° C.), or about 600° F. (343° C.) to about 750° F. (399° C.), or about 600° F. (343° C.) to about 700° F. (371° C.). The remaining portion of the total liquid product can be suitable as a blendstock, optionally after further hydrotreatment, for diesel fuel, fuel oil, heating oil, and/or marine gas oil.

In some aspects, a higher boiling fraction from processing of a blended feed including catalytic slurry oil and SCT can have a substantial content of polycyclic hydrocarbons and/or polycyclic hydrocarbonaceous compounds. For example, the 850° F.+(454° C.+) portion of the hydrotreated effluent can include about 50 wt % to about 100 wt % of polycyclic hydrocarbonaceous compounds (such as polycyclic hydrocarbons), or about 60 wt % to about 100 wt %, or about 70 wt % to about 100 wt %. Additionally or alternately, a portion of the hydrotreated effluent (or at least a 454° C.+ portion of the hydrotreated effluent) can optionally be hydroprocessed again to form a twice-hydroprocessed effluent. In such an optional aspect, the twice-hydroprocessed effluent can include aromatics, but the aromatics can be substantially all naphthenoaromatics. In some aspects, the total content of aromatics in any twice-hydroprocessed portions of the 454° C.+ fraction can be about 5 wt % to 70 wt %, or about 10 wt % to about 60 wt %, or about 15 wt % to 50 wt %, while the content of aromatics different from naphthenoaromatics can be about 2.0 wt % or less, or about 1.0 wt % or less, or about 1000 wppm or less, such as down to substantially no content (0%) of aromatics different from naphthenoaromatics. In other aspects, the total content of aromatics in any twice-hydroprocessed portions of the 454° C.+ fraction can be about 0.1 wt % to 5.0 wt %, or about 0.1 wt % to about 2.5 wt %, or about 1.0 wt % to about 5.0 wt %, while the content of aromatics different from naphthenoaromatics can be about 1.0 wt % or less, or about 1000 wppm or less, such as down to substantially no content (0%) of aromatics different from naphthenoaromatics. In some aspects, at least 50 wt % of the polycyclic hydrocarbonaceous compounds can be naphthenes, or at least 60 wt %, or at least 70 wt %, or at least 80 wt %, such as up to 100 wt %. With regard to the naphthenoaromatics present in the 454° C.+ portion of a twice-hydroprocessed effluent, about 2000 wppm or less of the naphthenoaromatics can correspond to naphtenoaromatics containing 4 or more aromatic rings, or about 1000 wppm or less, or about 500 wppm or less, such as down to substantially no content (0%) of naphthenoaromatics having 4 or more aromatic rings. Additionally or alternately, the paraffin content of such a fraction can be about 10 wt % or less, or about 5.0 wt % or less, or about 2.0 wt % or less. As an example, such a fraction can have a T10 boiling point of at least 510° C., a T50 boiling point of at least 566° C., and/or a T90 boiling point of 621° C. or less. In the claims below, total ring content, naphthene content, and naphthenoaromatic content in a sample can be determined using FTICR-MS, optionally in combination with ¹³C-NMR.

The total liquid product, the bottoms portion of the total liquid product, and/or the lower boiling portion of the total liquid product after removing the bottoms can have an unexpectedly high content of aromatics, naphthenics, or aromatics and naphthenics. The total liquid product (or a fraction thereof) can have a relatively high hydrogen content in comparison with low sulfur fuel oil or ultra low sulfur fuel oil. The relatively high hydrogen content can be beneficial for having at least a comparable energy density in comparison with a fuel oil. The total liquid product (or fraction thereof) can have a relatively low content of paraffins, which can correspond to a product (or fraction) that can have good compatibility with various fuel oils and/or good low temperature operability properties, such as pour point and/or cloud point. The total liquid product (or a fraction thereof) can have a pour point of less than ˜30° C., or less than ˜15° C., or less than ˜0° C., such as down to about −24° C. or lower.

The liquid (C₃+) portion of the hydrotreated effluent and/or a bottoms portion of the hydrotreated effluent can have an aromatics content of about 50 wt % to about 80 wt %, or about 60 wt % to about 75 wt %, or about 55 wt % to about 70 wt %; and a saturates content of about 25 wt % to about 45 wt %, or about 28 wt % to about 42 wt %. Additionally or alternately, the bottoms portion can have a pour point of about 30° C. to about −30° C., or about 30° C. to about −20° C., or about 0° C. to about −20° C. Additionally or alternately, the bottoms portion can have a kinematic viscosity at 50° C. of about 150 mm²/s to about 1000 mm²/s, or about 160 mm²/s to about 950 mm²/s. In some aspects, the total liquid product (or a fraction thereof, such as the bottoms fraction) can provide a beneficial combination of a low pour point with a low sulfur content. In particular, the pour point can be 15° C. or less with a sulfur content of 1000 wppm or less, or the pour point can be 10° C. or less with a sulfur content of 500 wppm or less, or the pour point can be 15° C. or less with a sulfur content of 300 wppm or less.

Potentially due in part to the aromatics content of the bottoms, the bottoms portion of the hydrotreated effluent can have a bureau of mines correlation index (BMCI) value of at least about 70, or at least about 80, or at least about 85, such as up to about 100 or more. Additionally or alternately, the bottoms portion of the hydrotreated effluent can have a calculated carbon aromaticity index (CCAI) of about 900 or less, or about 870 or less, such as down to about 800 or still lower.

### Feedstock—High Solvency Aromatic Fractions and Deasphalter Rock

The catalytic slurry oil and steam cracker tar feeds described above are examples of high solvency aromatic fractions. Other examples of high solvency aromatic fractions include coker bottoms and aromatic extract fractions generated during solvent processing to form lubricant base oils

With regard to heavy coker gas oils, suitable heavy coker gas oils can have an initial boiling point or T5 distillation point of at least about 600° F. (316° C.), and/or a T10 distillation point of at least about 650° F. (343° C.), and a T90 distillation point of about 1050° F. (566° C.) or less, and/or a T95 distillation point or final boiling point of about 1150° F. (621° C.) or less, or about 1100° F. (593° C.) or less. Similar to main column bottoms, heavy coker gas oils can have a sufficiently high solubility number and/or a sufficiently low rate of solubility number reduction to allow for co-processing of heavy coker gas oils with deasphalter rock.

Coking is a thermal cracking process that is suitable for conversion of heavy feeds into fuels boiling range products. The feedstock to a coker typically also includes 5 wt % to 25 wt % recycled product from the coker, which can be referred to as coker bottoms. This recycle fraction allows metals, asphaltenes, micro-carbon residue, and/or other solids to be returned to the coker, as opposed to being incorporated into a coker gas oil product. This can maintain a desired product quality for the coker gas oil product, but results in a net increase in the amount of light ends and coke that are generated by a coking process. Instead of using the coker bottoms as a recycle stream to the coker, a coker bottoms stream can be used as a high solvency aromatic fraction for slurry hydroconversion with deasphalter rock. The coker bottoms can correspond to a fraction with a T10 distillation point of at least 550° F. (288° C.), or at least 300° C., or at least 316° C., and a T90 distillation point of 566° C. or less, or 550° C. or less, or 538° C. or less. The coker recycle fraction can have an aromatic carbon content of about 20 wt % to about 50 wt %, or about 30 wt % to about 45 wt %, and a micro carbon residue content of about 4.0 wt % to about 15 wt %, or about 6.0 wt % to about 15 wt %, or about 4.0 wt % to about 10 wt %, or about 6.0 wt % to about 12 wt %. A typical coker bottoms stream has an S_{BN} between 90 and 120.

Lube extracts refer to aromatic extract fractions that can be formed during solvent processing of a feedstock to form (Group I) lubricant base stocks. Similar to main column bottoms, lube extracts fractions can have a sufficiently high solubility number and/or a sufficiently low rate of solubility number reduction to allow for co-processing of lube extracts with deasphalter rock.

Deasphalter residue or rock corresponds to a secondary fraction generated during a solvent deasphalting process. During solvent deasphalting, the feed to a deasphalting unit can be mixed with a solvent. Portions of the feed that are soluble in the solvent are then extracted, leaving behind a residue with little or no solubility in the solvent. The portion of the deasphalted feedstock that is extracted with the solvent is often referred to as deasphalted oil. Typical solvent deasphalting conditions include mixing a feedstock fraction with a solvent in a weight ratio of from about 1:2 to about 1:10, such as about 1:8 or less. Typical solvent deasphalting temperatures range from 40° C. to 200° C., or 40° C. to 150° C., depending on the nature of the feed and the solvent. The pressure during solvent deasphalting can be from about 50 psig (345 kPag) to about 500 psig (3447 kPag).

It is noted that the above solvent deasphalting conditions represent a general range, and the conditions will vary depending on the feed. For example, under typical deasphalting conditions, increasing the temperature can tend to reduce the yield while increasing the quality of the resulting deasphalted oil. Under typical deasphalting conditions, increasing the molecular weight of the solvent can tend to increase the yield while reducing the quality of the resulting deasphalted oil, as additional compounds within a resid fraction may be soluble in a solvent composed of higher molecular weight hydrocarbons. Under typical deasphalting conditions, increasing the amount of solvent can tend to increase the yield of the resulting deasphalted oil. As understood by those of skill in the art, the conditions for a particular feed can be selected based on the resulting yield of deasphalted oil from solvent deasphalting. In various aspects, the yield of deasphalted oil from solvent deasphalting with a C-C₄ solvent can be 25 wt % to 45 wt %, with corresponding yields of deasphalter rock of 55 wt % to 75 wt % relative to the weight of the feed to deasphalting. This type of desphalting (such as propane deasphalting) can be referred to as low yield deasphalting. Low yield deasphalting is the typical deasphalting process used in many refinery processes, such as lubricant base oil production. By contrast, during high yield deasphalting, the yield of deasphalted oil from solvent deasphalting with a C₄₊ solvent can be at least 50 wt % relative to the weight of the feed to deasphalting, or at least 60 wt %, or at least 65 wt %, or at least 70 wt %, such as up to 95 wt % or more. In aspects where the feed to deasphalting includes a gas oil boiling range portion, such as gas oil boiling range portions due to the presence of one or more cracked components within the feed, the yield from solvent deasphalting can be characterized based on a yield by weight of a 950° F.+(510° C.) portion of the deasphalted oil relative to the weight of a 510° C.+ portion of the feed. In such aspects where a C₄₊ solvent is used, the yield of 510° C.+ deasphalted oil from solvent deasphalting can be at least 40 wt % relative to the weight of the 510° C.+ portion of the feed to deasphalting, or at least 50 wt %, or at least 60 wt % or at least 65 wt %, or at least 70 wt % (such as up to 95 wt % or more). Additionally or alternately, the total yield can be at least 80 wt %, or at least 90 wt %, or at least 96 wt % (such as up to 99 wt % or more).

It is noted that high lift (i.e., high DAO yield) deasphalting can tend to produce deasphalter rock of lower quality than the typical rock from conventional deasphalting. The properties of high lift deasphalter rock can be improved by including about 10 wt % or more of a cracked component in the feed to deasphalting. Cracked components such as catalytic slurry oil, coker gas oil, steam cracker tar, coal tar, and/or visbreaker gas oil can correspond to fractions where a substantial portion of the fraction has a distillation point below 566° C. As a result, even under high lift deasphalting conditions, a portion of the deasphalter rock generated from cracked components has a distillation point below 566° C. This can improve various properties of the rock to allow for introduction into a coker. In various aspects, at least 5 wt % of the rock generated by high lift deasphalting of a feed including a cracked fraction can have a distillation point of 566° C. or less, or at least 10 wt %, or at least 15 wt %, or at least 20 wt %, such as up to 30 wt % or still higher.

### Slurry Hydroconversion

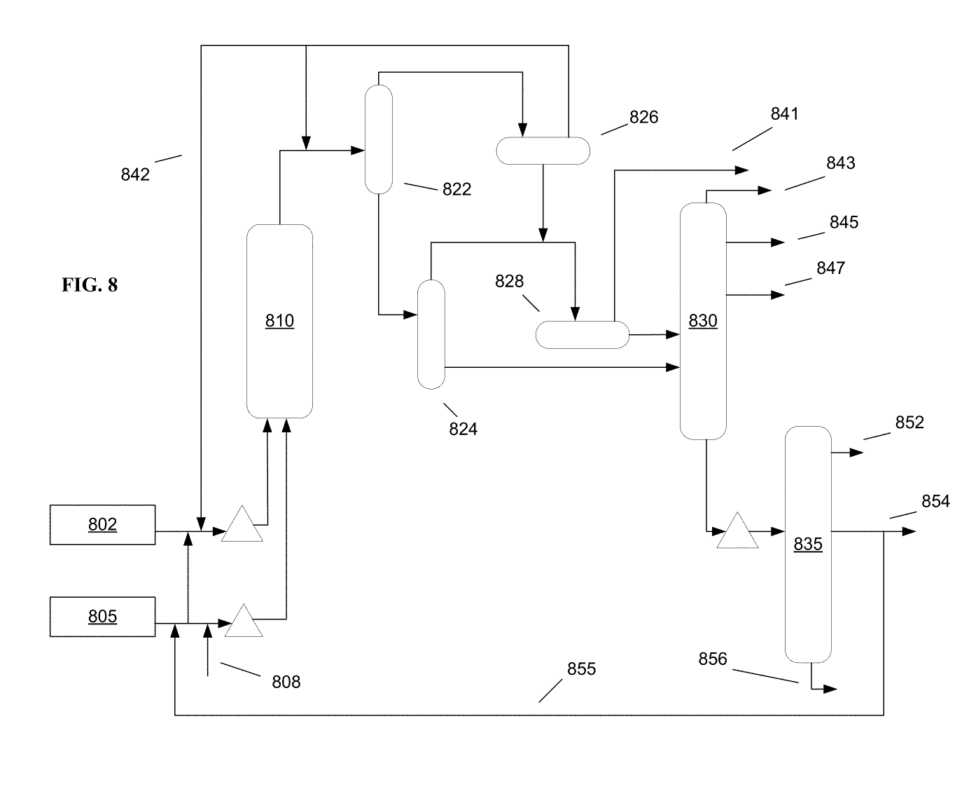

FIG. 8 shows an example of a reaction system suitable for performing slurry hydroconversion. The configuration in FIG. 8 is provided as an aid in understanding the general features of a slurry hydroconversion process. It should be understood that, unless otherwise specified, the conditions described in association with FIG. 8 can generally be applied to any convenient slurry hydroconversion configuration.

In FIG. 8, a heavy oil feedstock 805 is mixed with a catalyst 808 prior to entering one or more slurry hydroconversion reactors 810. The mixture of feedstock 805 and catalyst 808 can be heated prior to entering reactor 810 in order to achieve a desired temperature for the slurry hydroconversion reaction. A hydrogen stream 802 is also fed into reactor 810. In the configuration shown in FIG. 8, both the feedstock 805 and hydrogen stream 802 are shown as being heated prior to entering reactor 810. Optionally, a portion of feedstock 805 can be mixed with hydrogen stream 802 prior to hydrogen stream 802 entering reactor 810. Optionally, feedstock 805 can also include a portion of recycled vacuum gas oil 855. Optionally, hydrogen stream 802 can also include a portion of recycled hydrogen 842.

The effluent from slurry hydroconversion reactor(s) 810 is passed into one or more separation stages. For example, an initial separation stage can be a high pressure, high temperature (HPHT) separator 822. A higher boiling portion from the HPHT separator 822 can be passed to a low pressure, high temperature (LPHT) separator 824 while a lower boiling (gas) portion from the HPHT separator 822 can be passed to a high temperature, low pressure (HTLP) separator 826. The higher boiling portion from the LPHT separator 824 can be passed into a fractionator 830. The lower boiling portion from LPHT separator 824 can be combined with the higher boiling portion from HPLT separator 826 and passed into a low pressure, low temperature (LPLT) separator 828. The lower boiling portion from HPLT separator 826 can be used as a recycled hydrogen stream 842, optionally after removal of gas phase contaminants from the stream such as H₂S or NH₃. The lower boiling portion from LPLT separator 828 can be used as a flash gas or fuel gas 841. The higher boiling portion from LPLT separator 828 is also passed into fractionator 830.

In some configurations, HPHT separator 822 can operate at a temperature similar to the outlet temperature of the slurry HDC reactor 810. This reduces the amount of energy required to operate the HPHT separator 822. However, this also means that both the lower boiling portion and the higher boiling portion from the HPHT separator 822 undergo the full range of distillation and further processing steps prior to any recycling of unconverted feed to reactor 810.

In an alternative configuration, the higher boiling portion from HPHT separator 822 is used as a recycle stream 818 that is added back into feed 805 for processing in reactor 810. In this type of alternative configuration, the effluent from reactor 810 can be heated to reduce the amount of converted material that is recycled via recycle stream 818. This allows the conditions in HPHT separator 822 to be separated from the reaction conditions in reactor 810.

In FIG. 8, fractionator 830 is shown as an atmospheric fractionator. The fractionator 830 can be used to form a plurality of product streams, such as a light ends or C₄₋ stream 843, one or more naphtha streams 845, one or more diesel and/or distillate (including kerosene) fuel streams 847, and a bottoms fraction. The bottoms fraction can then be passed into vacuum fractionator 835 to form, for example, a light vacuum gas oil 852, a heavy vacuum gas oil 854, and a bottoms or pitch fraction 856. Optionally, other types and/or more types of vacuum gas oil fractions can be generated from vacuum fractionator 835. The heavy vacuum gas oil fraction 854 can be at least partially used to form a recycle stream 855 for combination with heavy oil feed 805.

In a reaction system, slurry hydroconversion can be performed by processing a feed in one or more slurry hydroconversion reactors. The reaction conditions in a slurry hydroconversion reactor can vary based on the nature of the catalyst, the nature of the feed, the desired products, and/or the desired amount of conversion.

With regard to catalyst, suitable catalyst concentrations can range from about 50 wppm to about 20,000 wppm (or about 2 wt %), depending on the nature of the catalyst. Catalyst can be incorporated into a hydrocarbon feedstock directly, or the catalyst can be incorporated into a side or slip stream of feed and then combined with the main flow of feedstock. Still another option is to form catalyst in-situ by introducing a catalyst precursor into a feed (or a side/slip stream of feed) and forming catalyst by a subsequent reaction.

Catalytically active metals for use in hydroconversion can include those from Group IVB, Group VB, Group VIB, Group VIIB, or Group VIII of the Periodic Table. Examples of suitable metals include iron, nickel, molybdenum, vanadium, tungsten, cobalt, ruthenium, and mixtures thereof. The catalytically active metal may be present as a solid particulate in elemental form or as an organic compound or an inorganic compound such as a sulfide (e.g., iron sulfide) or other ionic compound. Metal or metal compound nanoaggregates may also be used to form the solid particulates.

A catalyst in the form of a solid particulate is generally a compound of a catalytically active metal, or a metal in elemental form, either alone or supported on a refractory material such as an inorganic metal oxide (e.g., alumina, silica, titania, zirconia, and mixtures thereof). Other suitable refractory materials can include carbon, coal, and clays. Zeolites and non-zeolitic molecular sieves are also useful as solid supports. One advantage of using a support is its ability to act as a “coke getter” or adsorbent of asphaltene precursors that might otherwise lead to fouling of process equipment.

In some aspects, it can be desirable to form catalyst for slurry hydroconversion in situ, such as forming catalyst from a metal sulfate (e.g., iron sulfate monohydrate) catalyst precursor or another type of catalyst precursor that decomposes or reacts in the hydroconversion reaction zone environment, or in a pretreatment step, to form a desired, well-dispersed and catalytically active solid particulate (e.g., as iron sulfide). Precursors also include oil-soluble organometallic compounds containing the catalytically active metal of interest that thermally decompose to form the solid particulate (e.g., iron sulfide) having catalytic activity. Other suitable precursors include metal oxides that may be converted to catalytically active (or more catalytically active) compounds such as metal sulfides. In a particular embodiment, a metal oxide containing mineral may be used as a precursor of a solid particulate comprising the catalytically active metal (e.g., iron sulfide) on an inorganic refractory metal oxide support (e.g., alumina).

The reaction conditions within a slurry hydroconversion reactor can include a temperature of about 400° C. to about 490° C., or about 400° C. to about 450° C., or about 425° C. to about 490° C. Some types of slurry hydroconversion reactors are operated under high hydrogen partial pressure conditions, such as having a hydrogen partial pressure of about 1000 psig (6.9 MPag) to about 3400 psig (23.4 MPag), or about 1500 psig (10.3 MPag) to about 3400 psig (23.4 MPag), or about 2000 psig (13.8 MPag) to about 3400 psig (23.4 MPag), or about 1000 psig (6.9 MPag) to about 3000 psig (20.7 MPag), or about 1500 psig (10.3 MPag) to about 3000 psig (20.7 MPag). Since the catalyst is in slurry form within the feedstock, the space velocity for a slurry hydroconversion reactor can be characterized based on the volume of feed processed relative to the volume of the reactor used for processing the feed. Suitable space velocities for slurry hydroconversion can range, for example, from about 0.05 v/v/hr⁻¹ to about 2 v/v/hr⁻¹, such as about 0.1 v/v/hr⁻¹ to about 1 v/v/hr⁻¹. Hydrogen treat gas can be fed to the reactor at a rate of about 3000 scf/bbl to about 10000 scf/bbl (˜490 m³/m³ to ˜1700 m³/m³)

The reaction conditions for slurry hydroconversion can be selected so that the net conversion of feed across all slurry hydroconversion reactors (if there is more than one arranged in series) is at least about 80%, such as at least about 90%, or at least about 95%. For slurry hydroconversion, conversion is defined as conversion of compounds with boiling points greater than a conversion temperature, such as 975° F. (524° C.), to compounds with boiling points below the conversion temperature. Alternatively, the conversion temperature for defining the amount of conversion can be 1050° F. (566° C.). The portion of a heavy feed that is unconverted after slurry hydroconversion can be referred to as pitch or a bottoms fraction from the slurry hydroconversion.

After slurry hydroconversion, a hydrotreatment stage (such as a fixed bed hydrotreatment stage) can be used to further reduce the amount of heteroatom contaminants in the slurry hydroconversion products. Hydrotreatment is typically used to reduce the sulfur, nitrogen, and aromatic content of a feed. The catalysts used for hydrotreatment of the heavy portion of the crude oil from the flash separator can include conventional hydroprocessing catalysts, such as those that comprise at least one Group VIII non-noble metal (Columns 8-10 of IUPAC periodic table), preferably Fe, Co, and/or Ni, such as Co and/or Ni; and at least one Group VI metal (Column 6 of IUPAC periodic table), preferably Mo and/or W. Such hydroprocessing catalysts optionally include transition metal sulfides that are impregnated or dispersed on a refractory support or carrier such as alumina and/or silica. The support or carrier itself typically has no significant/measurable catalytic activity. Substantially carrier- or support-free catalysts, commonly referred to as bulk catalysts, generally have higher volumetric activities than their supported counterparts.

The catalysts for hydrotreatment after a slurry hydroconversion process can either be in bulk form or in supported form. In addition to alumina and/or silica, other suitable support/carrier materials can include, but are not limited to, zeolites, titania, silica-titania, and titania-alumina. Suitable aluminas are porous aluminas such as gamma or eta having average pore sizes from 50 to 200 Å, or 75 to 150 Å; a surface area from 100 to 300 m²/g, or 150 to 250 m²/g; and a pore volume of from 0.25 to 1.0 cm³/g, or 0.35 to 0.8 cm³/g. More generally, any convenient size, shape, and/or pore size distribution for a catalyst suitable for hydrotreatment of a distillate (including lubricant base oil) boiling range feed in a conventional manner may be used. It is within the scope of the present invention that more than one type of hydroprocessing catalyst can be used in one or multiple reaction vessels.

The at least one Group VIII non-noble metal, in oxide form, can typically be present in an amount ranging from about 2 wt % to about 40 wt %, preferably from about 4 wt % to about 15 wt %. The at least one Group VI metal, in oxide form, can typically be present in an amount ranging from about 2 wt % to about 70 wt %, preferably for supported catalysts from about 6 wt % to about 40 wt % or from about 10 wt % to about 30 wt %. These weight percents are based on the total weight of the catalyst. Suitable metal catalysts include cobalt/molybdenum (1-10% Co as oxide, 10-40% Mo as oxide), nickel/molybdenum (1-10% Ni as oxide, 10-40% Co as oxide), or nickel/tungsten (1-10% Ni as oxide, 10-40% W as oxide) on alumina, silica, silica-alumina, or titania.

The hydrotreatment (post-slurry hydroconversion) is carried out in the presence of hydrogen. A hydrogen stream is, therefore, fed or injected into a vessel or reaction zone or hydroprocessing zone in which the hydroprocessing catalyst is located. Hydrogen, which is contained in a hydrogen “treat gas,” is provided to the reaction zone. Treat gas, as referred to in this invention, can be either pure hydrogen or a hydrogen-containing gas, which is a gas stream containing hydrogen in an amount that is sufficient for the intended reaction(s), optionally including one or more other gasses (e.g., nitrogen and light hydrocarbons such as methane), and which will not adversely interfere with or affect either the reactions or the products. Impurities, such as H₂S and NH₃ are undesirable and would typically be removed from the treat gas before it is conducted to the reactor. The treat gas stream introduced into a reaction stage will preferably contain at least about 50 vol. % and more preferably at least about 75 vol. % hydrogen.

Hydrotreating conditions (post-slurry hydroconversion) can include temperatures of 200° C. to 450° C., or 315° C. to 425° C.; pressures of 250 psig (1.8 MPag) to 5000 psig (34.6 MPag) or 300 psig (2.1 MPag) to 3000 psig (20.8 MPag); liquid hourly space velocities (LHSV) of 0.1 hr⁻¹ to 10 hr⁻¹; and hydrogen treat rates of 200 scf/B (35.6 m³/m³) to 10,000 scf/B (1781 m³/m³), or 500 (89 m³/m³) to 10,000 scf/B (1781 m³/m³).

In some aspects, a hydrotreatment stage after slurry hydroconversion can be operated under conditions that are influenced by the conditions in the slurry hydroconversion reactor. For example, the effluent from slurry hydroconversion can be separated using a high pressure separator, operating at roughly the pressure of the slurry hydroconversion reactor, and then passed into the hydrotreatment reactor. In this type of aspect, the pressure in the hydrotreatment reactor can be the same as or similar to the pressure in the slurry hydroconversion reactor. In other aspects, after separation the fuels and gas phase products from the slurry hydroconversion reactor can be passed into a hydrotreatment reactor. This allows hydrogen originally passed into the slurry hydroconversion reactor to be used as the hydrogen source for hydrotreatment.

### Example of Fixed Bed Reaction System Configuration

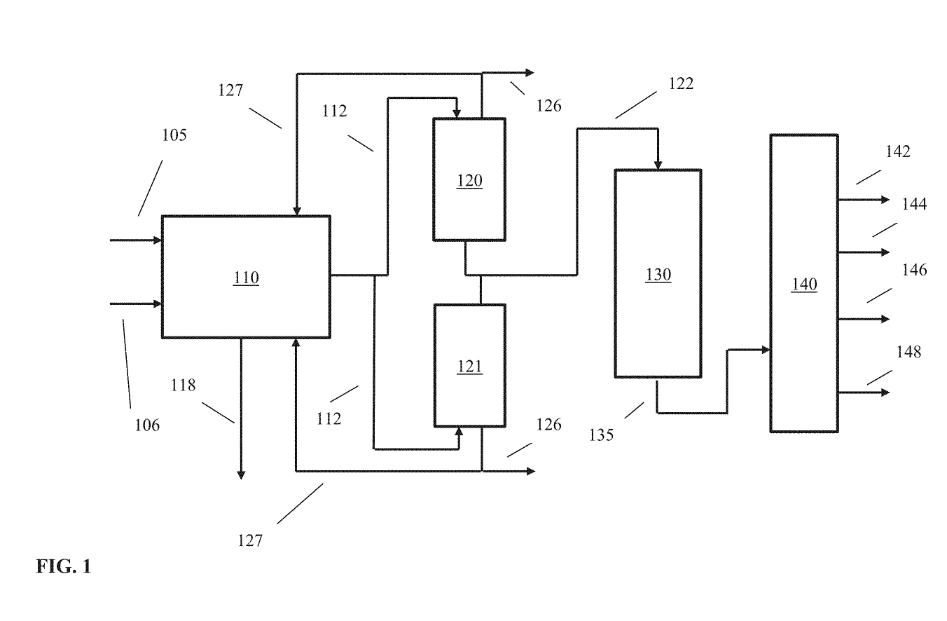

FIG. 1 schematically shows an example of a reaction system for processing a feed including both catalytic slurry oil and steam cracker tar. In FIG. 1, an initial feed 105 including catalytic slurry oil and a feed 106 including steam cracker tar can be introduced into a settling tank 110. Optionally, feed 105 and feed 106 can be combined prior to entering settling tank 110.

The blended feed can remain in the settling tank for a sufficient amount of time to allow for separation of the blended feed into a settler effluent 112 having a reduced content of particles and a settler bottoms 118 having an increased content of particles. The bottoms from the settler can go to a coker, an FCC unit, or directly to landfill. The settler effluent 112 can exit from the settler via a settler outlet and then be passed through one or more electrostatic separators, such as electrostatic separators 120 and 121, to produce an electrostatically separated settler effluent 122 having a further reduced particle content. The electrostatically separated settler effluent 122 can then be passed into fixed bed hydroprocessing reactor 130, such as a hydrotreating reactor, to produce a hydroprocessed effluent 135. Hydroprocessed effluent 135 can then optionally be separated into one or more desired fractions, such as by separation in a fractionator 140. This can allow for formation of, for example, one or more light ends fractions 142, one or more naphtha boiling range fractions 144, one or more diesel boiling range fractions 146, and/or one or more heavier or bottoms fractions 148. In the exemplary reaction system shown in FIG. 1, two electrostatic separators 120 and 121 are shown that operate in parallel. This can allow one electrostatic separator (such as separator 120) to remove particles from settler effluent 112 while a second electrostatic separator 121 can be in a flush or regeneration cycle. More generally, any convenient number of electrostatic separators can be used, such as having electrostatic separator 120 represent a plurality of separators and having electrostatic separator 121 represent a plurality of separators. The regeneration effluent 126 can be used, for example, as a feed for a coker or fluid catalytic cracking unit. Optionally, a portion 127 of the regeneration effluent 126 can be recycled back to settling tank 110.

### EXAMPLE 1

### Particle Removal

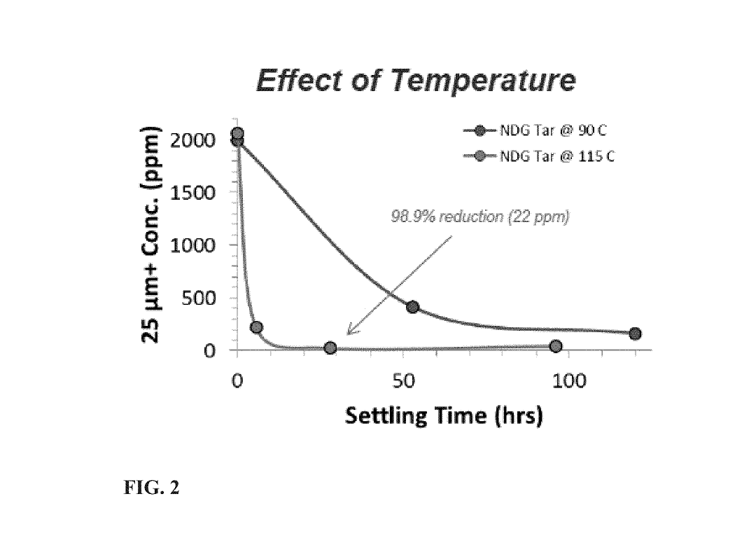

To demonstrate the effectiveness of settling for particle removal, settling was performed on steam cracker tar samples at various temperatures and for various lengths of time. A steam cracker tar feed or a feed including about 50 wt % of a steam cracker tar and about 50 wt % of Exxon Mobil Aromatic 200 fluid was introduced into a settling tank. This latter mixture was used to investigate the impact of a lower viscosity mixture on settling rates. The feeds were held in a settling tank at a temperature of about room temperature (˜25° C.), about 90° C., or about 115° C. for the settling times shown in FIGS. 2 to 4. The steam cracker tar feed included about 2200 wppm of particles having a particle size of 25 μm or greater.

FIG. 2 shows the settling rate for the steam cracker tar feed at temperatures of 90° C. and 115° C. The settling rate curve corresponding to 115° C. is indicated by the arrow in the figure. As shown in FIG. 2, increasing the temperature in the settling tank to 115° C. substantially increases the rate of particle settling, resulting in an almost 99% reduction of 25 μm or greater particles in a settler effluent after about 30 hours. This demonstrates that using a temperature of at least 100° C., or at least 110° C., can be beneficial for achieving a faster settling rate.

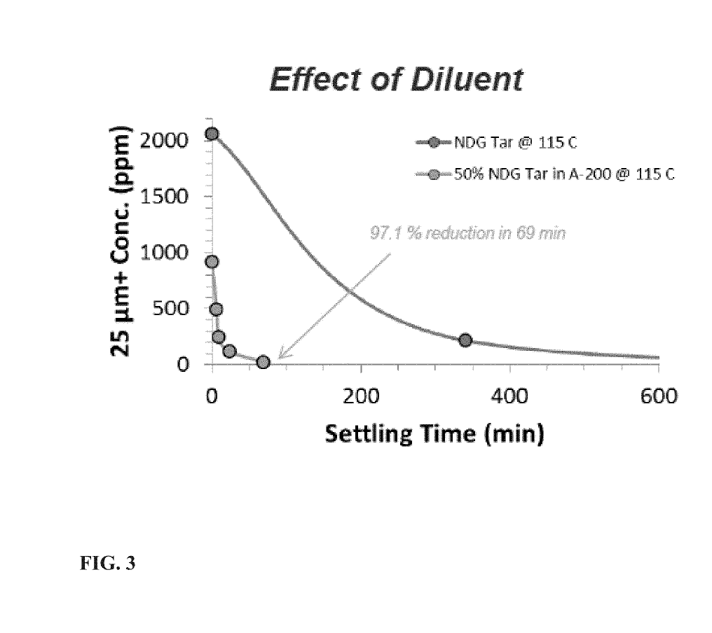

FIG. 3 shows a comparison of settling rate for the steam cracker tar feed and for the feed including 50 wt % steam cracker tar at a settling tank temperature of about 115° C. The settling rate curve for the feed including 50 wt % steam cracker tar is indicated by the arrow in the figure. FIG. 3 shows that addition of the diluent to the steam cracker tar can substantially increase the settling rate.

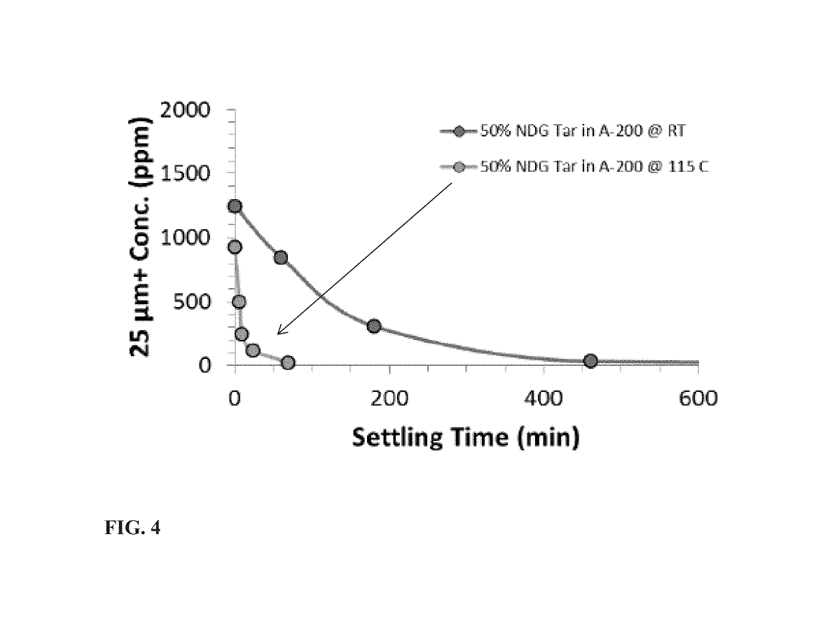

FIG. 4 shows the settling rate for the feed including 50 wt % steam cracker tar at temperatures of about 25° C. and about 115° C. The settling rate curve corresponding to 115° C. is indicated by the arrow in the figure. Similar to FIG. 2, performing settling at a temperature of at least about 100° C. can substantially improve the settling rate for particles having a particle size of about 25 μm or greater. Based on FIGS. 2 to 4, it also appears that the settling rate has a first order relationship with temperature (i.e., first order kinetics).

Based on the results in FIGS. 2 to 4, settling can provide a suitable method for reducing the content of particles of greater than 25 μm. The effluent from settling can then be passed into an electrostatic separator to further reduce the particle content prior to hydroprocessing.

### EXAMPLE 2

### Fixed Bed Hydrotreatment of Catalytic Slurry Oil

Catalytic slurry oils derived from a plurality of FCC processes were mixed together to form a combined catalytic slurry oil feed. The combined catalytic slurry oil feed had a T10 distillation point of about 670° F. (˜354° C.), a T50 of about 800° F. (˜427° C.), and a T90 of about 1000° F. (˜538° C.). The combined catalytic slurry oil feed included about 12 wt % micro carbon residue, about 3 wt % sulfur, a nitrogen content of about 2500 wppm, and a hydrogen content of about 7.4 wt %. The combined catalytic slurry oil feed had a density of about 1.12 g/cm³ and included about 10 wt % saturates, about 70 wt % 4+ ring aromatics, and about 20 wt % 1 to 3 ring aromatics. The combined catalytic slurry oil was also filtered prior to processing to remove catalyst fines so that a resulting permeate had a total particle content of less than about 25 wppm. The filtered permeate formed from the combined catalytic slurry oil feed was hydrotreated in a fixed bed hydrotreatment unit (pilot scale) in the presence of a commercially available supported medium pore NiMo hydrotreatment catalyst.

At the beginning of the run the hydrotreatment conditions included a pressure of about 2600 psig (˜17.9 MPag), an LHSV of about 0.25 hr⁻¹, a temperature of about 370° C., and a hydrogen treat gas rate of about 10,000 SCF/bbl (˜1700 Nm³/m³). These conditions were sufficient to reduce the sulfur content of the total liquid effluent to about 125 wppm. At start of run, fractionation of the total product resulted in 3 wt % H₂S, 1 wt % C₄₋, 5 wt % naphtha (C₅-177° C.), 47 wt % diesel boiling range product (177° C.-371° C.) having a sulfur content of less than 10 wppm, and 45 wt % of 371° C.+ product (including ˜2.5 wt % of 566° C.+ product). The 371° C.+ product had a specific gravity of about 1.0 g/cm³ and was suitable for use as a hydrocracker feed, an FCC feed, or for sale as a fuel oil.

The reactor was run for roughly 300 days. At the end of the run the hydrotreatment conditions included a pressure of about 2600 psig (˜17.9 MPag), an LHSV of about 0.25 hr⁻¹, a temperature of about 410° C., and a hydrogen treat gas rate of about 10,000 SCF/bbl (˜1700 Nm³/m³). The sulfur content in the total liquid effluent at end of run was about 117 wppm. At end of run, fractionation of the total product resulted in 3 wt % H₂S, 3 wt % C₄₋, 8 wt % naphtha (C₅-177° C.), 45 wt % diesel boiling range product (177° C.-371° C.) having a sulfur content of less than 10 wppm, and 41 wt % of 371° C.+ product. At end of run, the conversion rate for the 566° C.+ portion of the initial feed was greater than about 90%. The 371° C.+ product had a specific gravity of about 1.0 g/cm³ and was suitable for use as a hydrocracker feed, an FCC feed, or for sale as a fuel oil.

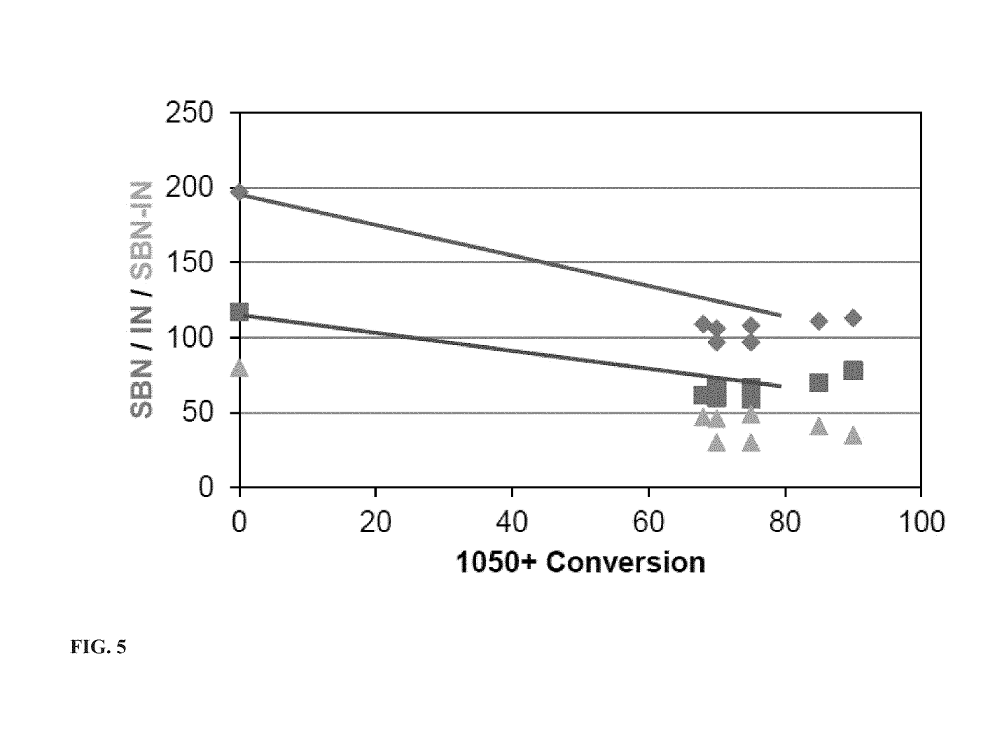

The increases in temperature to maintain the target sulfur in the effluent resulted in additional conversion over the course of the run. Although the higher temperatures shifted the boiling range distribution toward lighter products, the reactor otherwise remained stable for hydroprocessing throughout the run. This stability can be seen, for example, in the relationship between I_{N} and S_{BN} for the liquid effluent over the course of the run. FIG. 5 shows I_{N}, S_{BN}, and S_{BN}−I_{N} as a function of 1050° F.+(566° C.+) conversion during the run for processing of the catalytic slurry oil feed. The diamonds in FIG. 5 correspond to S_{BN} values as a function of 566° C.+ conversion, the squares correspond to I_{N} values as a function of conversion, and the triangles correspond to differences between the S_{BN} and I_{N} values at a given amount of conversion. The upper line in FIG. 5 corresponds to a fit to the S_{BN} values, while the lower line in FIG. 5 corresponds to a fit to the I_{N} values. As shown in FIG. 5, the I_{N} remained sufficiently below the S_{BN} for the products at all conversion values so that precipitation of asphaltenes and/or other particles did not occur within the reactor.

### EXAMPLE 3

### Fixed Bed Hydrotreatment of Steam Cracker Tar

A steam cracker tar feed was hydrotreated under conditions similar to the conditions from Example 2. The steam cracker tar feed had a T10 distillation point of about 420° F. (˜216° C.), a T50 of about 680° F. (˜360° C.), and a T90 of about 1300° F. (˜704° C.). The blended feed included about 22 wt % micro carbon residue, about 3.3 wt % sulfur, a nitrogen content of about 1100 wppm, and a density of about 1.16 g/cm³. The steam cracker tar feed was filtered to form a permeate having a total particle content to less than about 25 wppm. The permeate was exposed to a supported medium pore NiMo catalyst in a pilot testing unit similar to the configuration used in Example 2. After 7 days of processing the pressure drop in the unit was greater than 100 psig (˜0.7 MPag), which made further processing impractical. The catalyst in the reactor was fused together with coke and had to be drilled out of the reactor.

### EXAMPLE 4

### Hydrotreatment of Blended Feed (Catalytic Slurry Oil and SCT)—Comparison at Constant Severity

A catalytic slurry oil and the steam cracker tar of Example 3 were mixed in a weight ratio of 80:20 to form a blended feed. The blended feed had a T10 distillation point of about 550° F. (˜288° C.), a T50 of about 782° F. (˜417° C.), and a T90 of about 984° F. (˜529° C.). The blended feed included about 12 wt % micro carbon residue, about 3 wt % sulfur, a nitrogen content of about 1600 wppm, and a density of about 1.11 g/cm³. As noted above, the feed was filtered prior to hydrotreatment to reduce the total particle content to less than 25 wppm. The feed was exposed to a supported medium pore NiMo catalyst similar to the catalyst of Example 2 in a pilot scale fixed bed reactor. In this example, the reaction conditions were maintained at roughly constant severity, including constant temperature. The reaction conditions included a pressure of about 2000 psig (˜13.8 MPag), an LHSV of either about 0.3 hr^{—1} or about 0.5 hr⁻¹, a temperature of about 370° C., and a hydrogen treat gas rate of about 10,000 SCF/bbl (˜1700 Nm³/m³). Initially, the catalyst was exposed to a feed including just the catalytic slurry oil for 42 days. The feed was then switched to the blended feed for an additional 48 days. No plugging was observed in the reactor.

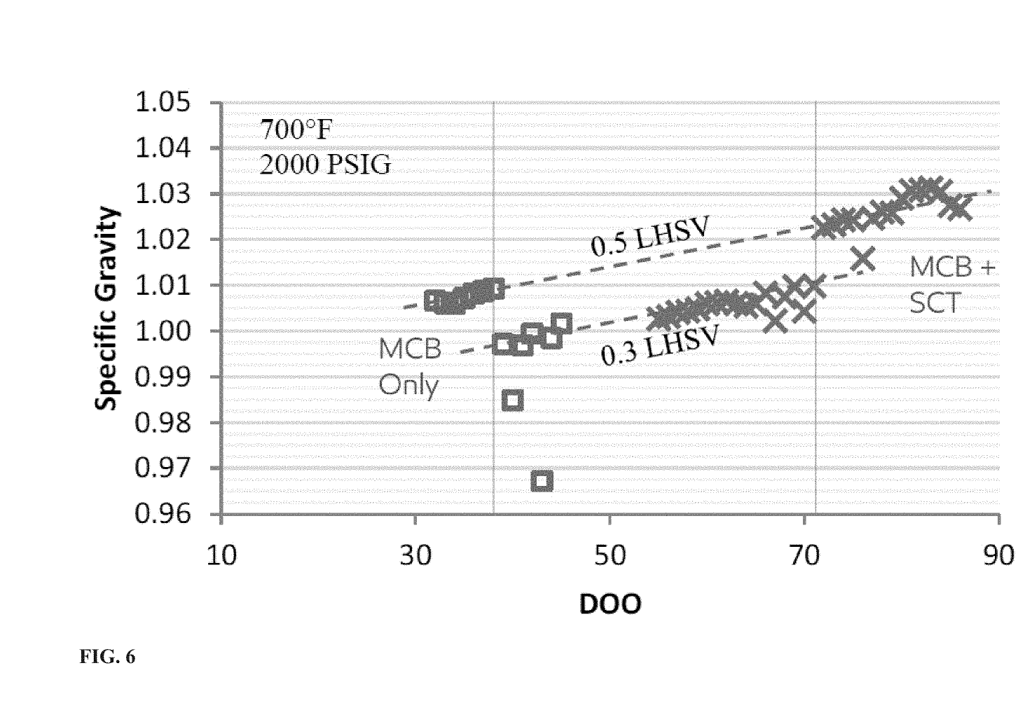

FIG. 6 shows the total liquid product density from the processing run over the course of the 90 days on oil (DOO). The squares in the left portion of FIG. 6 (initial part of the processing run) correspond to a feed composed only of “main column bottoms” or MCB, which is another term used to refer to catalytic slurry oil. The “x” symbols in the right portion of FIG. 6 correspond to a feed including catalytic slurry oil and 20 wt % of steam cracker tar (SCT). As shown in FIG. 6, the addition of 20 wt % SCT to the catalytic slurry oil did not result in a change in the processing trend line for the density of the total liquid effluent at either of the tested space velocities. It is noted that the temperature was maintained at about 370° C. during these runs, as opposed to increasing the temperature to maintain a desired sulfur target. Thus, the increased sulfur content from processing the blended feed is believed to be substantially due to typical catalyst deactivation that is typically compensated for by increasing the temperature during the course of a processing run.

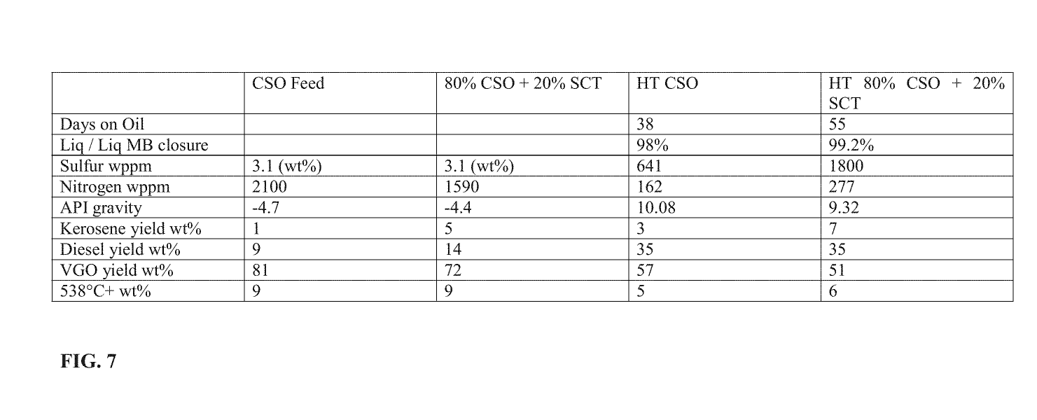

FIG. 7 provides a further comparison of the properties of the feeds tested in this example and the resulting hydrotreated liquid effluents. As shown in FIG. 7, other than boiling point differences related to the differences between the feeds, the hydrotreated effluent from processing of the blended feed was qualitatively similar to the hydrotreated effluent from processing of the catalytic slurry oil. This was unexpected given the conventional wisdom that SCT is not suitable for fixed bed hydrotreatment, as well as in view of the results from Example 3.

### EXAMPLE 5

### Hydrotreatment of Blended Feed (Catalytic Slurry Oil and SCT)

The catalytic slurry oil of Example 2 and the steam cracker tar of Example 3 were mixed in an 80:20 weight ratio to form a blended feed. The blended feed was filtered to reduce the total particle content to less than about 25 wppm. The blended feed was processed in the presence of a catalyst similar to the catalyst in Example 2, and in a reactor similar to the reactor in Example 2. The blended feed in this example had a T10 distillation point of about 583° F. (˜306° C.), a T50 of about 786° F. (˜419° C.), and a T90 of about 1020° F. (˜549° C.). The blended feed in this example included about 11 wt % micro carbon residue, about 3 wt % sulfur, a nitrogen content of about 1600 wppm, and a density of about 1.11 g/cm³. The reaction conditions at start of run included a pressure of about 2400 psig (˜16.5 MPag), an LHSV of about 0.25 hr⁻¹, a temperature of about 370° C., and a hydrogen treat gas rate of about 10,000 SCF/bbl (˜1700 Nm³/m³).

At start of run, fractionation of the total product resulted in 3 wt % H₂S, 1 wt % C₄₋, 5 wt % naphtha (C₅-177° C.), 51 wt % diesel boiling range product (177° C.-371° C.) having a sulfur content of less than 10 wppm, and 40 wt % of 371° C.+ product. The sulfur content of the total liquid product was 75 wppm. It is noted that this lower sulfur content in the total liquid product was achieved at a lower pressure than the start of run conditions in Example 2 (16.5 MPag in Example 5 vs. 17.9 MPag in Example 2). Additionally, the yield of diesel boiling range products is increased relative to Example 2 (51 wt % vs 47 wt %) while the yield of 371° C.+ products is decreased (40 wt % vs 45 wt %). It was unexpected that addition of a difficult to process fraction to a catalytic slurry oil could actually improve the yield of the more desirable diesel boiling range products for the blended feed. The diesel boiling range products were suitable for use, for example, as a diesel fuel blendstock. The processing run was continued for 50 days without plugging. The catalyst deactivation in this run appeared to be similar to the deactivation in Example 2 for processing of the catalytic slurry oil feed.

### EXAMPLE 6

### Characterization of Hydrotreated Effluent

A blended feed was formed by combining about 80 wt % of a catalytic slurry oil with about 20 wt % of a steam cracker tar. The catalytic slurry oil had the properties shown in Table 1.

TABLE 1
Catalytic Slurry Oil Properties

| | |
|---|---|
| Density @ 15.6° C. (g/cm³) | 1.12 |
| Sulfur (wt %) | 3.9 |
| Nitrogen (wppm) | 1800 |
| Micro Carbon Residue (wt %) | 9.5 |
| n-heptane insolubles (wt %) | 3.3 |
| Hydrogen content (wt %) | 7.2 |
| Viscosity @ 80° C. (cSt) | 67 |
| Viscosity @ 105° C. (cSt) | 20 |
| SIMDIS distillation | |
| T10 (° F./° C.) | 672/356 |
| T50 | 791/422 |
| T90 | 964/518 |
| 1050° F. + (566° C.+) fraction (wt %) | 6 |

The steam cracker tar feed included a steam cracker vacuum gas oil portion. The steam cracker tar feed had the properties shown in Table 2.

TABLE 2
Steam Cracker Tar Properties

| | |
|---|---|
| Density @ 15.6° C. (g/cm³) | 1.10 |
| Density @ 70° C. (g/cm³) | 1.06 |
| Density @ 90° C. (g/cm³) | 1.05 |
| API Gravity | −2.63 |
| Sulfur (wt %) | 2.7 |
| Nitrogen (wppm) | 860 |
| Micro Carbon Residue (wt %) | 17.9 |
| n-heptane insolubles (wt %) | 8.6 |
| Hydrogen content (wt %) | 7.1 |
| SIMDIS distillation | |
| T5 (° F./° C.) | 385/196 |
| T50 | 644/340 |
| T90 | 1143/617 |

Both the catalytic slurry oil and the blended feed of catalytic slurry oil and steam cracker tar were hydroprocessed in the presence of a commercially available supported NiMo hydrotreating catalyst at liquid hourly space velocities between about 0.25 hr⁻¹ and 1.0 hr⁻¹, temperatures between about 360° C. and about 420° C., a pressure of about 2400 psig (16.5 MPag), and a hydrogen treat gas rate of about 10,000 scf/b (1700 Nm³/m³). For both the catalytic slurry oil feedstock and the blended feedstock, about 20 wt % to 60 wt % of the feedstock was converted to a 700° F.−(371° C.-) product suitable for blending into a diesel fuel pool. At higher severity operation a 371° C.− product could be obtained from both types of feedstock that had a sulfur content of about 20 wppm or less.

The 850° F.+(454° C.+) fraction of the hydrotreated effluent (from either the catalytic slurry oil or the blended feed) could be further hydroprocessed to form resins and/or adhesives. After additional high severity hydrogenation, such as the conditions described in Example 7, the twice hydroprocessed product was composed primarily of 4-7 ring polycyclic hydrocarbons, with at least 50 wt % of the polycyclic hydrocarbons corresponding to polycyclic naphthenes.

The twice hydroprocessed 454° C.+ fraction included aromatics, with substantially all of the aromatics corresponding to naphthenoaromatics. Less than about 1000 wppm of the naphthenoaromatics corresponded to naphthenoaromatics with 4 or more aromatic rings.

### Example 7

### Comparison of Coking and Slurry hydroconversion for Light and Heavy Feeds

The benefits of using both coking and slurry hydroconversion for treatment of heavy feeds can be shown based on a comparison of the liquid yields for coking and slurry hydroconversion on feeds with different Conradson carbon residue values. Table 3 shows properties for vacuum resid fractions generated from crude oils from two different sources. Feed 1 in Table 3 represents a lighter feed while Feed 2 corresponds to a heavier feed. As shown in Table 3, the Conradson carbon residue for Feed 1 is 24.1 wt % while the residue value for Feed 2 is 33.5 wt %.

TABLE 3
Feed Properties

| Vacuum Resid Properties | Feed 1 | Feed 2 |
|---|---|---|
| Specific Gravity | 1.035 | 1.082 |
| Sulfur, wt % | 4.55 | 6.22 |
| Nitrogen, wt % | 0.38 | 0.88 |
| CCR, wt % | 24.1 | 33.5 |
| Nickel, wppm | 27.1 | 182.4 |
| Vanadium, wppm | 94.5 | 463.6 |
| Asphaltenes, wt % | 9.0 | 30.5 |
| Cut Vol %, 975° F. + | 18.3 | 35.4 |
| (524° C.+) | | |
| Cut Vol %, 1050° F. + | 14.1 | 29.1 |
| (566° C.+) | | |

Table 4 shows the resulting products from processing the vacuum resid feeds in Table 3 using a variety of processes. In Table 4, “Delayed Coke” refers to an example of using a delayed coking process to process a feed. “Slurry HDP (average)” refers to the average results from performing multiple different types of slurry hydroconversion on a feed, including slurry hydroconversion performed under different reactor conditions (e.g., temperature, H₂ pressure) and different reactor configurations. It is noted that the total liquid product yield from slurry hydroconversion was relatively constant at a constant level of conversion. For each of the slurry hydroconversion methods in the average, the total liquid product yield differed for Feed 1 and Feed 2 by less than 3 wt % of the feedstock.

The “conversion” row in Table 4 represents the amount of conversion of feedstock relative to a 975° F. (524° C.) cut point for separating vacuum gas oil from bottoms or pitch from the slurry hydroconversion process. For the conversion row, the range of conversion values tested for the three types of slurry hydroconversion is indicated instead of providing the average value. For coking, the amount of “conversion” is not provided, as some of the “conversion” performed during coking results in formation of coke instead of liquid products. The individual products shown correspond to light ends, naphtha, distillate (fuels), vacuum gas oil (VGO), coke or pitch (depending on whether the process is coking or slurry HDP), and hydrogen consumption. Light ends includes H₂S, NH₃, water, and C1-C4 molecules.

TABLE 4

| | | Feed 1- | | Feed 2- |
|---|---|---|---|---|
| | Feed 1- | Slurry | Feed 2- | Slurry |
| | Delayed | HDP | Delayed | HDP |
| | Coke | (average) | Coke | (average) |
| Conversion | | 90-97 | | 90-97 |
| (vol %) | | | | |
| Light ends (wt %) | 9.6 | 15.5 | 12.0 | 16.9 |
| Naphtha (wt %) | 11.1 | 16.0 | 10.7 | 16.0 |
| Distillate (wt %) | 21.5 | 40.5 | 18.0 | 40.5 |
| VGO (wt %) | 27.8 | 24.4 | 21.4 | 24.3 |
| Coke or Pitch | 30.0 | 6.1 | 37.9 | 6.0 |
| (wt %) | | | | |
| Hydrogen | 0 | 2000 | 0 | 2500 |
| Consumption | | (337 Nm³/m³) | | (421 Nm³/m³) |
| (scf/B) | | | | |

As shown in Table 4, the liquid product yield from slurry hydroconversion is relatively constant at a constant level of conversion. For each of the slurry hydroconversion methods, the total liquid product yield differed for Feed 1 and Feed 2 by less than 3 wt % of the feedstock. Due to the heavier nature of Feed 2, additional hydrogen is consumed to achieve the liquid product yield. However, the amount of total liquid product relative to the amount of feedstock is relatively similar, even though the CCR content of Feed 1 is about 10 wt % higher than the CCR value for Feed 1.

By contrast, coking of Feed 1 and Feed 2 results in production of substantially different amounts of total liquid product. Coking of Feed 1 results in a total liquid product of about 61 wt % of the original feed. Coking of Feed 2 results in a total liquid product of about 50 wt % of the original feed. Thus, a change of about 10 wt % in Conradson carbon value resulted in about a 10 wt % change in total liquid product.

Another way of understanding the results in Table 4 is to consider the marginal gain in liquid yield relative to the amount of hydrogen consumption. Performing slurry hydroconversion on Feed 1 resulted in an increase in total liquid yield of about 20 wt % relative to the feedstock, at the cost of using about 1700-2300 scf/B (287-388 Nm³/m³) of hydrogen. In comparison with Feed 1, performing slurry hydroconversion on Feed 2 resulted in an additional about 10 wt % of yield relative to the feedstock at a marginal increase in hydrogen consumption of about 400-700 scf/B (67-118 Nm³/m³). This demonstrates that use of slurry hydroconversion on the feed with a higher Conradson carbon value (Feed 2) provided a greater advantage relative to the amount of required hydrogen consumption. By selectively using coking to process less challenged feeds while using slurry hydroconversion to process higher Conradson carbon value (or otherwise more challenged) feeds, the hydrogen resources in a refinery can be preserved for higher value uses. This can allow more challenged feeds to be processed using slurry hydroconversion, so that a yield of at least about 55 wt % of liquid products, or at least about 60 wt % of liquid products, can be achieved for a more challenged feed.

### EXAMPLE 8

### Toluene Insoluble Production During Slurry Hydroconversion of Rock

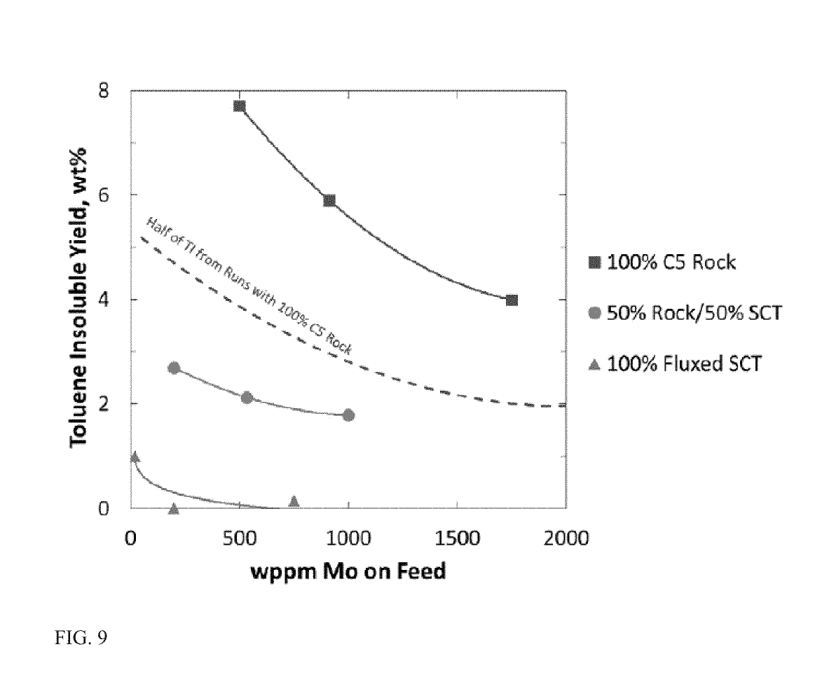

Deasphalter rock and steam cracker tar feeds were processed under slurry hydroconversion conditions using a Mo catalyst. The slurry hydroconversion conditions included a hydrogen partial pressure of roughly 2000 psig (˜13.8 MPag) and a temperature of roughly 450° C. FIG. 9 shows the amount of toluene insolubles present in the hydroconversion effluent for slurry hydroconversion of three feeds at various concentrations of the Mo catalyst. It is noted that based on the low catalyst concentration, the toluene insoluble content in the hydroconversion effluent roughly corresponds to the coke content. The feeds corresponded to 100% of deasphalter rock from pentane deasphalting (C₅ rock), 100% fluxed steam cracker tar, and a 50/50 blend by weight of the C₅ rock and fluxed steam cracker tar. For the fluxed steam cracker tar feed, roughly 25 wt % of the feed (such as 20 wt %-30 wt %) corresponded to a virgin and/or hydrotreated vacuum gas oil boiling range fraction. As shown in FIG. 9, the effluent from slurry hydroconversion of the C₅ rock resulted in toluene insoluble yields of roughly 4 wt % to 8 wt % relative to the feed, depending on the amount of Mo catalyst. A dashed line is included in FIG. 9 to represent the amount of toluene insolubles that would be expected based on simple dilution of the feed by 50 wt % with a feed containing no toluene insolubles. As shown in FIG. 9, the effluent from slurry hydroconversion of the fluxed steam cracker tar resulted in little or no yield of toluene insolubles. Therefore, it would have been expected for the 50/50 blend by weight of fluxed steam cracker tar and C₅ rock to produce a toluene insolubles amount similar to the dashed line in FIG. 9. However, the 50/50 blend by weight of C₅ rock and steam cracker tar produced a substantially lower amount of toluene insolubles relative to the expected amount, with the unexpected decrease being more pronounced at lower catalyst concentrations. In particular, without being bound by any particular theory, it appears that increasing the catalyst concentration has decreasing additional benefit at higher catalyst concentrations. At lower concentrations, such as 1000 wppm or less, or 500 wppm. Thus, at lower catalyst concentrations, a higher synergistic benefit is observed relative to the expected level of toluene insolubles present in an effluent based on simple dilution of a deasphalter rock feed. This demonstrates that processing deasphalter rock with an aromatic co-feed can provide an unexpected synergistic benefit for reducing the amount of toluene insolubles in the slurry hydroconversion effluent.

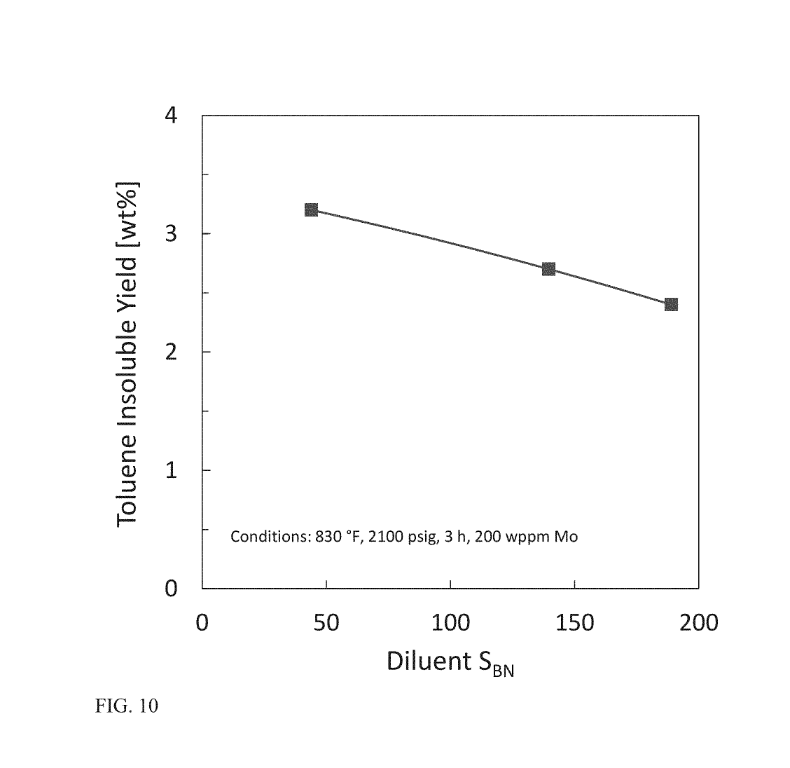

Additional processing runs were performed using the C₅ rock as part of the slurry hydroconversion feed. FIG. 10 shows results from slurry hydroconversion of feeds containing 50 wt % of the C₅ rock and 50 wt % of a co-feed corresponding to a virgin vacuum gas oil, the fluxed steam cracker tar, or a catalytic slurry oil. The catalyst concentration for the processing runs shown in FIG. 10 was about 200 wppm. The slurry hydroconversion conditions included a hydrogen partial pressure of roughly 2100 psig (˜14.5 MPag) and a temperature of 443° C. (830° F.).

As shown in FIG. 10, co-processing of the C₅ rock with virgin vacuum gas oilappeared to result in primarily a dilution effect on the amount of toluene insolubles. Co-processing with the virgin vacuum gas oil also resulted in phase separation and inhomogeneity within the reactor liquid. Without being bound by any particular theory, it is believed that the low S_{BN} value for the virgin vacuum gas oil (<50) contributed to the occurrence of phase separation in the reactor. Such phase separation within a slurry hydroprocessing environment can pose difficulties for maintaining control over reaction conditions within a reactor. By contrast, co-processing with either the fluxed steam cracker tar or the catalytic slurry oil resulted in a synergistic reduction in the amount of toluene insolubles beyond the diluent effect observed when virgin vacuum gas oil was used. Without being bound by any particular theory, it is believed that using a co-feed with a S_{BN} value of 110 or more (such as fluxed SCT), or 150 or more (such as catalytic slurry oil) resulted in improved solubility of various types of compounds within the slurry processing environment. This improved solubility is believed to allow certain types of compounds to remain in solution during slurry hydroprocessing both before and after conversion, resulting in a corresponding reduction in the amount of formation of toluene insoluble products. Additionally, no phase separation / inhomogeneity was observed in the reactor when using the fluxed steam cracker tar or catalytic slurry oil as a co-feed. As shown in FIG. 10, co-processing the C5 rock with fluxed steam cracker tar or the catalytic slurry oil reduced the toluene insolubles content of the hydroprocessed effluent to below 3.0 wt % at a catalyst concentration of roughly 200 wppm.

### Additional Embodiments

Embodiment 1. A method for hydroprocessing of deasphalter rock, comprising: exposing a feed comprising a challenged fraction and a co-feed to a hydroprocessing catalyst under hydroprocessing conditions to form a hydroprocessed effluent, the co-feed comprising 10 wt % or less of n-heptane insolubles, a S_{BN} of about 90 or more, a I_{N} of about 50 or more, a T10 distillation point of at least 343° C., and a T90 distillation point of 566° C. or less, the feed comprising about 20 wt % or more of the co-feed and about 10 wt % or more of the challenged fraction, the co-feed and the challenged fraction comprising 50 wt % or more of the feed, wherein a) the challenged fraction comprises deasphalter rock comprising at least 10 wt % n-heptane insolubles and the hydroprocessing conditions comprise slurry hydroprocessing conditions; or b) the challenged fraction comprises steam cracker tar, the co-feed comprises catalytic slurry oil, the feedstock comprises a total particle content of about 100 wppm or less and an API Gravity of 7 or less, and the hydroprocessing conditions comprise fixed bed hydrotreating conditions.

Embodiment 2. A method for processing a feed including steam cracker tar, comprising: exposing a feed comprising a) about 60 wt % to about 99 wt % (or about 70 wt % to about 99 wt %) of a catalytic slurry oil portion, based on a weight of the feed, that includes a ˜650° F.+(˜343° C.+) portion and that has an I_{N} of at least about 50 and b) about 1.0 wt % to about 30 wt % of a steam cracker tar portion (based on weight of the feed) to a hydrotreating catalyst in a fixed bed under effective hydrotreating conditions to form a hydrotreated effluent, the feed having a total particle content of about 100 wppm or less and an API gravity of 7 or less (or 5 or less, or 0 or less), a liquid portion of the hydrotreated effluent having an API gravity that is at least 5 greater than the API gravity of the feed (or at least 10 greater, or at least 15 greater).

Embodiment 3. The method of Embodiment 1 or 2, further comprising separating a feedstock comprising the catalytic slurry oil portion and the steam cracker tar portion to form at least a first separation effluent comprising the feed and a second separation effluent, the feedstock having a total particle content of at least about 200 wppm (or at least about 500 wppm, or at least about 1000 wppm), the second separation effluent comprising at least about 200 wppm of particles having a particle size of 25 μm or greater.

Embodiment 4. A method for processing a feed including steam cracker tar, comprising: separating a feed comprising a) about 60 wt % to about 99 wt % (or about 70 wt % to about 99 wt %) of a catalytic slurry oil portion, based on a weight of the feed, that includes a ˜650° F.+(˜343° C.+) portion and that has an I_{N} of at least about 50 and b) about 1.0 wt % to about 30 wt % (based on weight of the feed) of a steam cracker tar portion to form at least a first separation effluent having a total particle content of about 100 wppm or less and a second separation effluent comprising at least about 200 wppm of particles having a particle size of 25 p.m or greater; and exposing the first separation effluent to a hydrotreating catalyst in a fixed bed under effective hydrotreating conditions to form a hydrotreated effluent, the first separation effluent having an API gravity of 7 or less (or 5 or less, or 0 or less), a liquid portion of the hydrotreated effluent having a API gravity that is at least 5 greater than the API gravity of the feed (or at least 10 greater, or at least 15 greater).

Embodiment 5. The method of Embodiment 4, wherein separating the feed comprises settling the feed in a settling vessel for a settling time to form a settler effluent and a settler bottoms, the settler bottoms comprising at least about 200 wppm of particles having a particle size of 25 μm or greater, the settling optionally being performed at a settling temperature of at least about 100° C.

Embodiment 6. The method of Embodiment 4 or 5, wherein separating the feed comprises passing at least a portion of the feedstock into an electrostatic separation stage to form a first electrostatic separation effluent having a total particle content lower than the total particle content of the feed and a second electrostatic separation effluent having a greater total particle content than the feed.

Embodiment 7. The method of any of the above embodiments, wherein the feed and/or the first separation effluent includes about 3 wt % to about 10 wt % (based on weight of the feed) of a ˜1050° F.+(˜566° C.+) portion, the effective hydrotreating conditions being effective for conversion of at least about 50 wt % of a ˜566° C.+ portion of the feed and/or first separation effluent, the effective hydrotreating conditions optionally consuming at least about 1500 SCF/bbl (˜260 Nm³/m³) of hydrogen.

Embodiment 8. The method of any of the above embodiments, wherein the feed and/or the first separation effluent further comprises 1 wt % to 30 wt % (based on weight of the feed) of a flux, the flux having a T5 boiling point of at least 343° C.

Embodiment 9. The method of any of the above embodiments, wherein the feed and/or the first separation effluent further comprises about 10 wt % or less (based on weight of the feed) of a fraction different from a catalytic slurry oil portion or a steam cracker tar portion.

Embodiment 10. The method of any of the above embodiments, wherein the feed and/or the first separation effluent comprises at least about 5 wt % (based on weight of the feed) of the steam cracker tar portion, or at least about 10 wt %, or at least about 15 wt %.

Embodiment 11. The method of any of the above embodiments, wherein the feed (or the first separation effluent) comprises a T10 distillation point of at least about 343° C.; or wherein the feed and/or the first separation effluent has a total particle content of about 50 wppm or less, or about 25 wppm or less; or a combination thereof

Embodiment 12. A hydroprocessing system, comprising: a settling tank; one or more stages of electrostatic separators comprising at least one separator stage inlet in fluid communication with the settling tank for receiving a settler effluent and at least one separator stage outlet; and a hydroprocessing reactor comprising a reactor inlet in fluid communication with the at least one separator stage outlet and a reactor outlet, the hydroprocessing reactor further comprising at least one fixed bed containing a hydroprocessing catalyst.

Embodiment 13. The hydroprocessing system of Embodiment 12, wherein the settling tank comprises a settler bottoms outlet in fluid communication with at least one of a coker, a fluid catalytic cracker, or a fuel oil pool.

Embodiment 14. The hydroprocessing system of Embodiment 12 or 13, wherein the one or more stages of electrostatic separators comprise electrostatic separators arranged in series, electrostatic separators arranged in parallel, or a combination thereof, the one or more stages of electrostatic separators optionally further comprising a separator stage flush outlet in fluid communication with at least one of a coker, a fluid catalytic cracker, or a fuel oil pool.

Embodiment 15. A liquid portion of a hydrotreated effluent made according to the method of any of Embodiments 1-11.

Embodiment 16. A liquid portion of a hydrotreated effluent formed by processing a feed including steam cracker tar, the hydrotreated effluent formed by the method comprising: separating a feed comprising a) about 60 wt % to about 99 wt % (or about 70 wt % to about 99 wt %) of a catalytic slurry oil portion, based on a weight of the feed, that includes a ˜650° F.+(˜343° C.+) portion and that has an I_{N} of at least about 50 and b) about 1.0 wt % to about 30 wt % of a steam cracker tar portion to form at least a first separation effluent having a total particle content of about 100 wppm or less and a second separation effluent comprising at least about 200 wppm of particles having a particle size of 25 μm or greater; and exposing the first separation effluent to a hydrotreating catalyst in a fixed bed under effective hydrotreating conditions to form a hydrotreated effluent, the first separation effluent having an API gravity of 7 or less (or 5 or less, or 0 or less), the liquid portion of the hydrotreated effluent having an API gravity of at least 5, the API gravity of the liquid portion of the hydrotreated effluent being at least 5 greater than the API gravity of the feed (or at least 10 greater, or at least 15 greater).

Embodiment 17. A method for slurry hydroprocessing of deasphalter rock, comprising: exposing a feed comprising deasphalter rock and a co-feed to a slurry hydroprocessing catalyst under slurry hydroprocessing conditions to form a hydroprocessed effluent, the deasphalter rock comprising at least 10 wt % n-heptane insolubles relative to a weight of the deasphalter rock, the co-feed comprising a S_{BN} of about 90 or more, a I_{N} of about 50 or more, a T10 distillation point of at least 343° C., and a T90 distillation point of 566° C. or less, the feed comprising about 20 wt % or more of the co-feed and about 10 wt % or more of the deasphalter rock, the co-feed and the deasphalter rock comprising 50 wt % or more of the feed.

Embodiment 18. The method of Embodiment 1 or 17, wherein the feed comprises about 30 wt % or more of the deasphalter rock, or about 50 wt % or more; or wherein the feed comprises about 30 wt % or more of the co-feed, or about 50 wt % or more; or wherein the co-feed and the deasphalter rock comprise 70 wt % or more of the feed, or 80 wt % or more; or a combination thereof.

Embodiment 19. The method of any of Embodiments 1, 17, or 18, wherein the feed comprises about 20 wt % or more of catalytic slurry oil, or about 40 wt % or more, or about 50 wt % or more; or wherein the feed comprises about 20 wt % or more of steam cracker tar, or about 40 wt % or more, or about 50 wt % or more.

Embodiment 20. The method of any of Embodiments 1 or 17-19, wherein the co-feed has a S_{BN} of about 110 or more, or about 120 or more, or about 150 or more, or wherein the co-feed has a I_{N} of about 70 or more, or about 90 or more; or a combination thereof.

Embodiment 21. The method of any of Embodiments 1 or 17-20, wherein the co-feed comprises a catalytic slurry oil, a steam cracker tar, a coker gas oil, an aromatics extract fraction, or a combination thereof.

Embodiment 22. The method of any of Embodiments 1 or 17-21, wherein the slurry hydroprocessing conditions are effective for conversion of at least 25 wt % of the deasphalter rock relative to 566° C., or at least 40 wt %, or at least 50 wt %.

Embodiment 23. The method of any of Embodiments 1 or 17-22, wherein the feed is exposed to 1000 wppm or less of slurry hydroprocessing catalyst, relative to a weight of the feed, or 500 wppm or less.

Embodiment 24. The method of any of Embodiments 1 or 17-23, wherein the hydroprocessed effluent comprises 3.0 wt % or less of toluene insoluble compounds, or 2.0 wt % or less.

Embodiment 25. A feed for slurry hydroprocessing, comprising: about 10 wt % or more of deasphalter rock, the deasphalter rock comprising at least 10 wt % n-heptane insolubles relative to a weight of the deasphalter rock; about 50 wt % or more of a co-feed comprising a SBN of about 90 or more, a I_{N} of about 50 or more, a T10 distillation point of at least 343° C., and a T90 distillation point of 566° C. or less; and about 100 wppm to about 1000 wppm of catalyst particles, the catalyst particles comprising a Group VIB metal.

Embodiment 26. The feed of Embodiment 25, wherein the co-feed comprises catalytic slurry oil, the feed comprising about 20 wt % or more of the catalytic slurry oil.

Embodiment 27. The feed of Embodiment 25 or 26, wherein the co-feed comprises a catalytic slurry oil, a steam cracker tar, a coker gas oil, an aromatics extract fraction, or a combination thereof.

Embodiment 28. The feed of any of Embodiments 25 to 27, wherein the co-feed has a I_{N} of about 70 or more, or about 90 or more; or wherein the co-feed has a S_{BN} of about 110 or more, or about 120 or more, or about 150 or more; or a combination thereof

Embodiment 29. The feed of any of Embodiments 25 to 28, wherein the Group VIB metal comprises Mo.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

The present invention has been described above with reference to numerous embodiments and specific examples. Many variations will suggest themselves to those skilled in this art in light of the above detailed description. All such obvious variations are within the full intended scope of the appended claims.

1. A method for processing a feed including steam cracker tar, comprising:
exposing a feed comprising
a) about 60 wt % to about 99 wt % of a catalytic slurry oil portion, based on a weight of the feed, that includes a ˜650° F.+(˜343° C.+) boiling range fraction and that has an I_{N} of at least about 50 and
b) about 1.0 wt % to about 30 wt % of a steam cracker tar portion
to a hydrotreating catalyst in a fixed bed under effective hydrotreating conditions to form a hydrotreated effluent, the feed having a total particle content of about 100 wppm or less and an API gravity of 7 or less, a liquid portion of the hydrotreated effluent having a API gravity that is at least 5 greater than the API gravity of the feed.

2. The method of claim 1, further comprising separating a feedstock comprising the catalytic slurry oil portion and the steam cracker tar portion to form a first separation effluent comprising the feed and a second separation effluent, the feedstock having a total particle content of at least about 200 wppm, the second separation effluent comprising at least about 200 wppm of particles having a particle size of 25 μm or greater.

3. The method of claim 1, wherein at least one of the catalytic slurry oil portion and the steam cracker tar portion comprises a portion exposed to a particle separation process.

4. The method of claim 1, wherein the feed includes about 3 wt % to about 10 wt % of a ˜1050° F.+(˜566° C.+) portion based on the weight of the feed, the effective hydrotreating conditions being effective for conversion of at least about 50 wt % of a ˜566° C.+ boiling range fraction of the feed, the effective hydrotreating conditions optionally consuming at least about 1500 SCF/bbl (˜260 Nm³/m³) of hydrogen.

5. The method of claim 1, wherein the feed further comprises about 10 wt % or less of a fraction different from a catalytic slurry oil portion or a steam cracker tar portion.

6. The method of claim 1, wherein the feed comprises at least about 5 wt % of the steam cracker tar portion.

7. The method of claim 1, wherein the feed comprises a T10 distillation point of at least about 650° F. (343° C.).

8. The method of claim 1, wherein the feed further comprises 1 wt % to 30 wt % of a flux, the flux having a T5 boiling point of at least 343° C.

9. A method for processing a feed including steam cracker tar, comprising:
separating a feed comprising
a) about 60 wt % to about 99 wt % of a catalytic slurry oil portion, based on a weight of the feed, that includes a ˜650° F.+(˜343° C.+) boiling range fraction and that has an I_{N} of at least about 50 and
b) about 1.0 wt % to about 30 wt % of a steam cracker tar portion
to form a first separation effluent having a total particle content of about 100 wppm or less and a second separation effluent comprising at least about 200 wppm of particles having a particle size of 25 μm or greater; and
exposing the first separation effluent having a total particle content of about 100 wppm or less to a hydrotreating catalyst in a fixed bed under effective hydrotreating conditions to form a hydrotreated effluent, the first separation effluent having an API gravity of 7 or less, a liquid portion of the hydrotreated effluent having a API gravity that is at least 5 greater than the API gravity of the feed.

10. The method of claim 9, wherein separating the feed comprises settling the feed in a settling vessel for a settling time to form a settler effluent and a settler bottoms, the settler bottoms comprising at least about 200 wppm of particles having a particle size of 25 μm or greater.

11. The method of claim 9, wherein separating the feed comprises passing at least a portion of the feedstock into an electrostatic separation stage to form a first electrostatic separation effluent having a total particle content lower than the total particle content of the feed and a second electrostatic separation effluent having a greater total particle content than the feed.

12. The method of claim 9, wherein the feed further comprises about 10 wt % or less of a fraction different from a catalytic slurry oil portion or a steam cracker tar portion.

13. The method of claim 9, wherein the feed comprises at least about 5 wt % of the steam cracker tar portion.

14. The method of claim 9, wherein the feed has a total particle content of about 50 wppm or less.

15. The method of claim 9, wherein the feed further comprises 1 wt % to 30 wt % of a flux, the flux having a T5 boiling point of at least 343° C.

16. A hydroprocessing system, comprising:
a settling tank;
one or more stages of electrostatic separators comprising at least one separator stage inlet in fluid communication with the settling tank for receiving a settler effluent and at least one separator stage outlet; and
a hydroprocessing reactor comprising a reactor inlet in fluid communication with the at least one separator stage outlet and a reactor outlet, the hydroprocessing reactor further comprising at least one fixed bed containing a hydroprocessing catalyst.

17. The hydroprocessing system of claim 16, wherein the settling tank comprises a settler bottoms outlet in fluid communication with at least one of a coker, a fluid catalytic cracker, or a fuel oil pool.

18. The hydroprocessing system of claim 16, wherein the one or more stages of electrostatic separators comprise electrostatic separators arranged in series, electrostatic separators arranged in parallel, or a combination thereof.

19. The hydroprocessing system of claim 16, wherein the one or more stages of electrostatic separators further comprise a separator stage flush outlet in fluid communication with at least one of a coker, a fluid catalytic cracker, or a fuel oil pool.

20. A liquid portion of a hydrotreated effluent formed by processing a feed including steam cracker tar, the hydrotreated effluent formed by the method comprising:
separating a feed comprising
a) about 60 wt % to about 99 wt % of a catalytic slurry oil portion, based on a weight of the feed, that includes a ˜650° F.+(˜343° C.+) boiling range fraction and that has an I_{N} of at least about 50 and
b) about 1.0 wt % to about 30 wt % of a steam cracker tar portion
to form an effluent having a total particle content of about 100 wppm or less and at least a second effluent comprising at least about 200 wppm of particles having a particle size of 25 μm or greater; and
exposing the effluent having a total particle content of about 100 wppm or less to a hydrotreating catalyst in a fixed bed under effective hydrotreating conditions to form a hydrotreated effluent, the feed having a total particle content of about 100 wppm or less and an API Gravity of 7 or less, the liquid portion of the hydrotreated effluent having an API gravity of at least 5, the API gravity of the liquid portion of the hydrotreated effluent being at least 5 greater than the API gravity of the feed.

21. A method for slurry hydroprocessing of deasphalter rock, comprising:
exposing a feed comprising deasphalter rock and a co-feed to a slurry hydroprocessing catalyst under slurry hydroprocessing conditions to form a hydroprocessed effluent, the deasphalter rock comprising at least 10 wt % n-heptane insolubles relative to a weight of the deasphalter rock, the co-feed comprising a S_{BN} of about 90 or more, a I_{N} of about 50 or more, a T10 distillation point of at least 343° C., and a T90 distillation point of 566° C. or less, the feed comprising about 20 wt % or more of the co-feed and about 10 wt % or more of the deasphalter rock, the co-feed and the deasphalter rock comprising 50 wt % or more of the feed.

22. The method of claim 21, wherein the feed comprises about 30 wt % or more of the deasphalter rock.

23. The method of claim 21, wherein the feed comprises about 30 wt % or more of the co-feed.

24. The method of claim 21, wherein the co-feed and the deasphalter rock comprise 70 wt % or more of the feed.

25. The method of claim 21, wherein the feed comprises about 20 wt % or more of catalytic slurry oil.

26. The method of claim 21, wherein the feed comprises about 20 wt % or more of steam cracker tar.

27. The method of claim 21, wherein the co-feed has a S_{BN} of about 110 or more.

28. The method of claim 21, wherein the co-feed has a I_{N} of about 70 or more.

29. The method of claim 21, wherein the co-feed comprises a catalytic slurry oil, a steam cracker tar, a coker gas oil, an aromatics extract fraction, or a combination thereof.

30. The method of claim 21, wherein the slurry hydroprocessing conditions are effective for conversion of at least 25 wt % of the deasphalter rock relative to 566° C.

31. The method of claim 21, wherein the feed is exposed to 1000 wppm or less of slurry hydroprocessing catalyst, relative to a weight of the feed.

32. The method of claim 21, wherein the hydroprocessed effluent comprises 3.0 wt % or less of toluene insoluble compounds.

33. A feed for slurry hydroprocessing, comprising:
about 10 wt % or more of deasphalter rock, the deasphalter rock comprising at least 10 wt % n-heptane insolubles relative to a weight of the deasphalter rock;
about 50 wt % or more of a co-feed comprising a S_{BN} of about 90 or more, a I_{N} of about 50 or more, a T10 distillation point of at least 343° C., and a T90 distillation point of 566° C. or less; and
about 100 wppm to about 1000 wppm of catalyst particles, the catalyst particles comprising a Group VIB metal.

34. The feed of claim 33, wherein the co-feed comprises catalytic slurry oil, the feed comprising about 20 wt % or more of the catalytic slurry oil.

35. The feed of claim 33, wherein the co-feed comprises a catalytic slurry oil, a steam cracker tar, a coker gas oil, an aromatics extract fraction, or a combination thereof

36. The feed of claim 33, wherein the co-feed has a I_{N} of about 70 or more.

37. The feed of claim 33, wherein the co-feed has a S_{BN} of about 110 or more.

38. The feed of claim 33, wherein the Group VIB metal comprises Mo.

39. A method for slurry hydroprocessing of deasphalter rock, comprising:
exposing a feed comprising a challenged fraction and a co-feed to a hydroprocessing catalyst under hydroprocessing conditions to form a hydroprocessed effluent, the co-feed comprising 10 wt % or less of n-heptane insolubles, a S_{BN} of about 90 or more, a I_{N} of about 50 or more, a T10 distillation point of at least 343° C., and a T90 distillation point of 566° C. or less, the feed comprising about 20 wt % or more of the co-feed and about 10 wt % or more of the challenged fraction, the co-feed and the challenged fraction comprising 50 wt % or more of the feed,
wherein a) the challenged fraction comprises deasphalter rock comprising at least 10 wt % n-heptane insolubles and the hydroprocessing conditions comprise slurry hydroprocessing conditions; or
b) the challenged fraction comprises steam cracker tar, the co-feed comprises catalytic slurry oil, the feedstock comprises a total particle content of about 100 wppm or less and an API Gravity of 7 or less, and the hydroprocessing conditions comprise fixed bed hydrotreating conditions.
